(19) United States
(12) Patent Application Publication
(10) Pub. No.: US 2024/0390890 A1
(43) Pub. Date: Nov. 28, 2024

(54) MULTI-MODALITY ADDITIVE MANUFACTURING OF MICROFLUIDIC SYSTEMS

(71) Applicant: UNIVERSITY OF MARYLAND, COLLEGE PARK, College Park, MD (US)

(72) Inventors: Ryan SOCHOL, Bethesda, MD (US); Sunandita SARKER, Silver Spring, MD (US); Ziteng WEN, Greenbelt, MD (US); Xin XU, Arlington, VA (US); Adira COLTON, Laurel, MD (US)

(21) Appl. No.: 18/674,396

(22) Filed: May 24, 2024

Related U.S. Application Data
(60) Provisional application No. 63/504,441, filed on May 25, 2023.

(51) Int. Cl. B01L 3/00; B29C 64/135; B29L 31/00; B33Y 10/00; B33Y 40/00; B33Y 80/00

(52) U.S. Cl. CPC B01L 3/502707; B29C 64/135; B33Y 10/00; B33Y 40/00; B33Y 80/00; B01L 2200/12; B29L 2031/712; B29L 2031/756

(57) ABSTRACT

A first structure of a microfluidic system is fabricated via a first additive manufacturing process. The first structure has at least one first fluidic port and at least one first conduit. Each first conduit connects to one of the at least one first fluidic port. A second structure of the microfluidic system is fabricated on the first structure via a second additive manufacturing process. The second structure has at least one second conduit. The second structure is fabricated such that the at least one second conduit is sealed to the at least one first fluidic port and such that the at least one first conduit is in fluid communication with the at least one second conduit. The second additive manufacturing process employs ex situ direct laser writing, while the first additive manufacturing process employs an additive manufacturing modality different from the second additive manufacturing process.

### CROSS-REFERENCE TO RELATED APPLICATION

The present application claims the benefit of U.S. Provisional Application No. 63/504,441, filed May 25, 2023, and entitled “Additive Manufacturing of Fluidic Structures,” which is hereby incorporated by reference herein in its entirety.

### STATEMENT REGARDING PRIOR DISCLOSURES

Pursuant to 35 U.S.C. § 102(b)(1)(A), the following were published by the instant inventors, each of which is incorporated by reference herein in its entirety:
SARKER et al., “A Hybrid 3D Micro-Nanoprinting Approach for Biomedical Microinjection Needle Arrays,” Proceedings of the 20th Solid-State Sensors, Actuators and Microsystems Workshop (Hilton Head 2022), June 2022, 4 pages.
SARKER et al., “3D-Printed Microinjection Needle Arrays via a Hybrid DLP-Direct Laser Writing Strategy,” Advanced Materials Technologies, Mar. 10, 2023 (published online Feb. 5, 2023), 8(5): paper no. 2201641, 13 pages.

### FIELD

The present disclosure relates generally to additive manufacturing, and more particularly, to fabricating microfluidic systems using different additive manufacturing modalities.

### BACKGROUND

Additive manufacturing, which offers a high degree of geometric control, has been employed to fabricate three-dimensional (3D) microstructures, such as microfluidic systems. For example, direct laser writing (DLW) is an AM technique that leverages the phenomenon of two-photon (or multiphoton) polymerization to create 3D structures from photocurable materials. By scanning a femtosecond pulsed infrared (IR) laser in a point-by-point, layer-by-layer fashion, DLW selectively crosslinks the photocurable material in targeted locations, thereby solidifying the structure. This technique offers exceptional resolution, with feature sizes achievable down to the 100-nm range, enabling the fabrication of highly intricate microfluidic channels and chambers.

Microfluidic systems often require interfaces between its microscale channels and the macroscale, for example, input and/or output fluidic ports. However, the inherent high-resolution nature of DLW presents a challenge when it comes to integrating larger macro-scale features with these microscale structures. For example, the submicrometer-scale resolution of the volume element (“voxel”) employed in DLW necessitates extensive and time-consuming laser scanning to create macroscopic features, leading to increased fabrication time and cost. In some cases, macroscale interfaces have been separately fabricated and subsequently coupled to DLW-formed microfluidic structures, often in a manual manner. However, the disparity in size between the microscale structures and the macroscale interfaces can make it difficult to establish reliable and robust fluidic connections.

Embodiments of the disclosed subject matter may address one or more of the above-noted problems and disadvantages, among other things.

### SUMMARY

Embodiments of the disclosed subject matter provide systems and methods for multi-modality additive manufacturing of microfluidic systems, as well as microfluidic systems formed by multi-modality additive manufacturing. In some embodiments, separate additive manufacturing modalities can be used to fabricate different structures of the microfluidic system, for example, with a first modality used to form a first structure, and a second modality used to form a second structure directly on and integrated with (e.g., fluidically sealed to) the first structure. For example, the first structure can provide a macroscale-to-microscale interface, while the second structure can have features (e.g., channels, ports, etc.) with microscale dimensions (e.g., ≤500 μm).

In one or more embodiments, a method of fabricating a microfluidic system can comprise fabricating a first structure of the microfluidic system via a first additive manufacturing process. The first structure can have at least one first fluidic port and at least one first conduit. Each first conduit can connect to one of the at least one first fluidic port. The method can further comprise fabricating a second structure of the microfluidic system on the first structure via a second additive manufacturing process. The second structure can have at least one second conduit. The fabricating the second structure on the first structure can be such that the at least one second conduit is sealed to the at least one first fluidic port and such that the at least one first conduit is in fluid communication with the at least one second conduit. The second additive manufacturing process can comprise ex situ direct laser writing, and the first additive manufacturing process can comprise an additive manufacturing modality different from the second additive manufacturing process.

In one or more embodiments, a microfluidic system can comprise a first structure and a second structure coupled to the first structure. The first structure can have at least one first fluidic port and at least one first conduit. Each first conduit can be connected to one of the at least one first fluidic port. The first structure can be formed by a first additive manufacturing process. The second structure can have at least one second conduit and can be formed by a second additive manufacturing process. The at least one second conduit can be sealed to the at least one first fluidic port, and the at least one first conduit can be in fluid communication with the at least one second conduit. The second additive manufacturing process can comprise ex situ direct laser writing, and the first additive manufacturing process can comprise an additive manufacturing modality different from the second additive manufacturing process.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of fabricating a microfluidic system using multiple additive manufacturing modalities, according to one or more embodiments of the disclosed subject matter.

FIG. 1B is a simplified schematic diagram illustrating fabrication of a base structure of a microfluidic system using a vat photopolymerization process, according to one or more embodiments of the disclosed subject matter.

FIG. 1C is a simplified schematic diagram illustrating fabrication of another structure on the base structure of the microfluidic system using an ex situ Direct Laser Writing (esDLW) process, according to one or more embodiments of the disclosed subject matter.

FIG. 1D is a simplified schematic diagram illustrating aspects of a microfluidic system comprising a microneedle array, according to one or more embodiments of the disclosed subject matter.

FIGS. 2A-2D illustrate aspects of microfluidic systems comprising soft robotic actuators, according to one or more embodiments of the disclosed subject matter.

FIGS. 3A-3B illustrate aspects of microfluidic systems comprising microvessels, according to one or more embodiments of the disclosed subject matter.

FIG. 4A is a process flow diagram for a method of fabricating a microfluidic system using multiple additive manufacturing modalities, according to one or more embodiments of the disclosed subject matter.

FIG. 4B is a simplified schematic diagram of a system for fabricating a microfluidic system using multiple additive manufacturing modalities, according to one or more embodiments of the disclosed subject matter.

FIG. 4C depicts a generalized example of a computing environment in which the disclosed technologies may be implemented.

FIG. 5A shows perspective, top, and cross-sectional views of a batch array of tubes formed via digital light processing (DLP) based 3D printing.

FIG. 5B shows perspective and cross-sectional views of a microneedle array (MNA) formed via esDLW.

FIG. 5C illustrates use of an integrated MNA-tube assembly with nanoinjector systems to facilitate MNA-mediated simultaneous, distributed microinjections of target fluidic substances or suspensions into brain tissue.

FIGS. 5D-5F show scanning electron microscopy (SEM) images of an esDLW-printed MNA formed atop a DLP-printed tube (with the scale bars representing 250 μm, 100 μm, and 25 μm, respectively).

FIGS. 6A-6B show results of finite element analysis (FEA) for microneedle deformations and stress-strain curve, respectively, corresponding to MNA mechanics under compressive loading conditions.

FIG. 6C show sequential images of an MNA during an axial compression test, with the inset showing an SEM image of the MNA following compressive failure (with scale bars representing 250 μm).

FIG. 6D shows stress-strain curves generated from compressive loading experiments.

FIGS. 6E-6G show sequential images of representative MNA penetrations and retraction operations corresponding to hydrogels with agarose concentrations of 2.4%, 5%, and 10%, respectively (with scale bars representing 500 μm).

FIGS. 7A-7C show quantified results for representative cyclic burst-pressure experiments (n=100 cycles) corresponding to input pressures targeting 100 kPa, 200 kPa, and 300 kPa, respectively.

FIG. 8A shows sequential images of MNA insertion into (≤20 seconds) and retraction from (≥20 seconds) brain tissue (with scale bar representing 1 mm).

FIG. 8B is an SEM image of the MNA after retraction from the brain tissue (with scale bar representing 250 μm).

FIG. 8C shows sequential images of a representative MNA penetration, microinjection, and retraction process for a surrogate fluid injected into brain tissue (with scale bar representing 1 mm).

FIG. 8D is a magnified image of the site in the brain tissue after the microinjection process of FIG. 8C (with scale bar representing 250 μm).

FIG. 8E is an SEM image of the MNA after the microinjection process of FIG. 8C (with scale bar representing 250 μm).

FIG. 9A shows sequential images of nanoparticle microinjection and retraction in vitro in 0.6% agarose gels (with scale bar representing 250 μm).

FIGS. 9B-9C are two-photon and widefield fluorescence microscopy images, respectively, of the injection site after the microinjection process of FIG. 9A (with scale bars representing 250 μm).

FIG. 9D shows mean fluorescence intensities of injection sites corresponding to microneedles in distinct array regions (n=3 MNAs).

FIG. 9E shows sequential images of MNA penetration, microinjection, and retraction process for a suspension of fluorescent nanoparticles injected into excised mouse brain tissue (with scale bar representing 1 mm).

FIGS. 9F-9G are two-photon fluorescence microscopy images of side and cross-sectional views, respectively, of the injection site in excised mouse brain tissue after injecting using a 33G needle (with scale bars representing 250 μm).

FIG. 9H shows quantified fluorescence intensities along the length of the cross-sectional view of FIG. 9G.

FIGS. 91-9J are two-photon fluorescence microscopy images of side and cross-sectional views, respectively, of the injection site in excised mouse brain tissue after the microinjection process of FIG. 9E (with scale bars representing 250 μm).

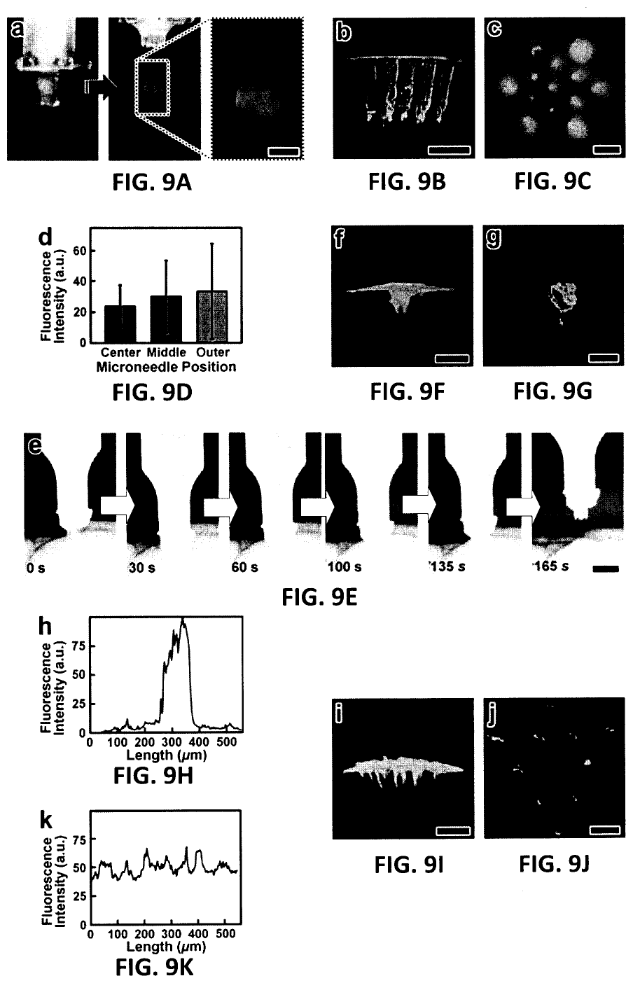

FIG. 9K shows quantified fluorescence intensities along the length of the cross-sectional view of FIG. 9J.

FIG. 10A illustrates operation of 3D microprinting integrated soft actuators formed atop a multi-lumen microfluidic tubing to induce tip bending, with the magnitude of deformation proportional to applied input pressure.

FIG. 10B shows computer-aided manufacturing (CAM) simulations (top) and corresponding micrographs of the esDLW process (bottom) for 3D microprinting (with scale bars representing 100 μm).

FIG. 10C shows images of the integrated soft actuators formed atop a dual-lumen microfluidic tubing (with scale bars representing 5 mm, 500 μm, and 100 μm, respectively).

FIG. 11A shows finite element simulation results for deformation behavior of an integrated soft actuator under pressure loads applied to the left actuator of 0 kPa (left), 120 kPa (middle), and 240 kPa (right), with no pressure applied to the right actuator.

FIG. 11B shows finite element simulation results for bending angle versus pressure applied only to the left actuator.

FIG. 11C shows finite element simulation results for tip displacement versus pressure applied only to the left actuator.

FIG. 12A shows sequential brightfield micrographs of the integrated soft actuators under pressure loads applied to the left actuator of 0 kPa (left), 80 kPa (middle), and 130 kPa (right), with no pressure applied to the right actuator (with scale bar representing 100 μm).

FIG. 12B shows experimental results for bending angle versus pressure applied only to the left actuator.

FIG. 12C shows experimental results for tip displacement versus pressure applied only to the left actuator.

FIG. 13A is a simplified schematic diagram of a liquid crystal display (LCD) 3D-printed microchip upon which robotic actuators can be formed.

FIG. 13B is a simplified schematic diagram illustrating 3D microprinting of an omnidirectional soft robotic actuator via esDLW.

FIG. 13C shows simulation (top) and corresponding micrographs (bottom) of esDLW 3D microprinting of the omnidirectional soft robotic actuator atop an LCD 3D-printed microchip (with scale bar representing 250 μm).

FIG. 13D show images of a fabricated omnidirectional soft robotic actuator (with scale bars indicating 10 mm (left), 250 μm (middle), and 250 μm (right)).

FIGS. 14A-14B show experimental results for cyclic microfluidic burst-pressure testing of the omnidirectional soft robotic actuator for 100 cycles (per distinct pressure) corresponding to cycles 1-5 and 95-100 for input pressures of 25 kPa and 50 kPa, respectively.

FIGS. 15A-15C show quantified results for the omnidirectional soft robotic actuator displacements under vacuum and positive pressure inputs ranging from −50 kPa to 50 kPa to actuators 1-3, respectively (with scale bars representing 250 μm).

FIG. 16A illustrates an esDLW process for 3D microprinting integrated soft robotic actuators onto tubing.

FIG. 16B illustrates an example of how a guidewire employing the integrated soft robotic actuators can traverse follow a patient's vasculature.

FIG. 16C shows examples of fabricated soft robotic actuators printed atop and fluidically sealed to tubing (with scale bars representing 1 mm).

FIG. 16D shows successive images of a surgical catheter sliding over the fabricated soft robotic actuators.

FIGS. 17A-17B show brightfield micrographs of curvature of a symmetric soft robotic actuator with zero pressure loading and with 600 kPa of pneumatic internal loading, respectively (with scale bars representing 500 μm).

FIG. 17C is graph of radius of curvature of the fabricated soft robotic actuator of FIG. 17A versus sequentially increased pressures loads.

FIGS. 18A-18B show brightfield micrographs of curvature of an asymmetric soft robotic actuator with zero pressure loading and with 600 kPa of pneumatic internal loading, respectively (with scale bars representing 500 μm).

FIG. 18C is graph of radius of curvature of the fabricated soft robotic actuator of FIG. 18A versus sequentially increased pressures loads.

FIGS. 19A-19B are graphs of displacements of the actuator tip and midpoint relative to their positions with zero pressure input for the symmetric soft robotic actuator of FIG. 17A and for the asymmetric soft robotic actuator of FIG. 18A, respectively.

FIG. 20A illustrates DLP 3D printing of a microfluidic chip and chip holder designed for esDLW and microscopy.

FIG. 20B illustrates esDLW 3D printing of microfluidic vessel structures using a PDMS-based photomaterial.

FIG. 20C shows SEM images of a fabricated esDLW-printed microvessel structure with pre-designed 5 μm pores (with scale bars representing 100 μm).

FIG. 21A is a confocal brightfield micrograph of a control (empty) microfluidic vessel structure (with scale bar representing 100 μm).

FIG. 21B is a fluorescence micrograph of the microfluidic vessel structure of FIG. 21A after coating with fibronectin (with scale bar representing 100 μm).

FIG. 21C is a fluorescence micrograph of the microfluidic vessel structure of FIG. 21B after culturing human umbilical vein endothelial cells (HUVEC) on the inner lumen (with scale bar representing 100 μm).

FIG. 21D is a merged fluorescence micrograph showing both fibronectin coating (blue) and HUVECs (red) (with scale bar representing 100 μm).

FIG. 22A illustrates vat photopolymerization (VPP) 3D printing of a microfluidic chip upon which 3D interweaving microvessels can be subsequently fabricated.

FIG. 22B illustrates esDLW 3D printing of microfluidic vessel structures using a PDMS-based photomaterial.

FIGS. 23A-23B shows fabricated structures having interweaving vessels and independent microvessels, respectively (with scale bar representing 100 μm).

FIGS. 24A-24B show confocal brightfield and fluorescence microscopy images, respectively, of a fabricated empty microfluidic vessel (with scale bar representing 100 μm).

FIG. 24C shows fluorescence microscopy image of the fabricated microfluidic vessel of FIGS. 24A-24B after culturing MDA-MB-231 cells on the inner lumen walls (with scale bar representing 100 μm).

FIGS. 25A-25D show experimental results for microenvironmental regulation in a fabricated microfluidic vessel with no pressure/vacuum, retained mainstream flow, partial external permeation, and high external permeation, respectively (with scale bar representing 250 μm).

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Microfluidic System: A system for conveying, processing, handling, or otherwise employing fluids in channels (e.g., conduits or lumina) having a maximum cross-sectional dimension (e.g., in a plane perpendicular to a flow of fluid therethrough) less than 1 mm (e.g., 500 μm or less). In some embodiments, the microfluidic system is comprised of at least two structures coupled (e.g., sealed) together. In some embodiments, the microfluidic system is configured to inject fluid (e.g., containing a drug or biological cells) into a sample (e.g., excised or living tissue). Alternatively or additionally, in some embodiments, the microfluidic system is configured to use pressure (e.g., liquid or gas) applied to one or more channels therein to actuate a device or end effector. Alternatively or additionally, in some embodiments, the microfluidic system is configured to contain and/or grow biological cells (e.g., human cells), for example, as a microphysiological system or organ-on-a-chip (OOC) system.

Additive Manufacturing: A manufacturing technique that employs iterative deposition, joining, and/or solidifying of precursor material (e.g., polymer, liquids, powder grains, etc.) based on a computer model (e.g., computer-aided design) to form a three-dimensional structure, for example, in a layer-by-layer and/or point-by-point manner. Also referred to herein as 3D printing. In some embodiments, a first structure of a microfluidic system can be formed by a first additive manufacturing modality, and a second structure of the microfluidic system can be formed by a second additive manufacturing modality different from the first additive manufacturing modality. In some embodiments, the first additive manufacturing modality can offer faster print speeds and/or be limited to larger feature sizes (e.g., maximum cross-sectional dimension of a conduit) as compared to the second additive manufacturing modality. For example, the first additive manufacturing modality can employ a vat photopolymerization process, and the second additive manufacturing modality can employ ex situ Direct Laser Writing.

ex situ Direct Laser Writing (esDLW): An additive manufacturing modality that uses two-photon (or multi-photon) polymerization to crosslink a photocurable material in a point-by-point, layer-by-layer manner, for example, by scanning a focused femtosecond infrared (IR) laser to polymerize the photomaterial in target locations on a substrate or support material. In some embodiments, the esDLW is used to form a second structure of a microfluidic system directly on and integrated (e.g., fluidically sealed) with a first structure of the microfluidic system. In some embodiments, the esDLW can be as described in Acevedo et al., “3D Nanoprinted External Microfluidic Structures via ex situ Direct Laser Writing,” Proceedings of the 2021 IEEE 34^{th} International Conference on Micro Electro Mechanical Systems (MEMS), January 2021, or Acevedo et al., “3D Nanoprinted Liquid-Core-Shell Microparticles,” Journal of Microelectromechanical Systems, October 2020, 29(5): pp. 924-29, each of which is incorporated by reference herein.

Vat Photopolymerization (VPP): An additive manufacturing modality that uses light-activated polymerization to create 3D structures from a vat of liquid resin in a layer-by-layer manner, for example, by raising or lowering a build platform to form successive layers. In some embodiments, the VPP employs an ultraviolet (UV) light source or laser. In some embodiments, the VPP is one of stereolithography (e.g., where a focused laser beam traces each layer of the structure in the vat of resin), digital light processing (DLP) 3D printing (e.g., where a digital micromirror device is used to create a patterned light exposure on the vat of resin for each layer) or liquid crystal display (LCD) 3D printing (e.g., where an LCD panel acts like a mask to create a patterned light exposure on the vat of resin for each layer). In some embodiments, the VPP is used to form a first structure of a microfluidic system.

### INTRODUCTION

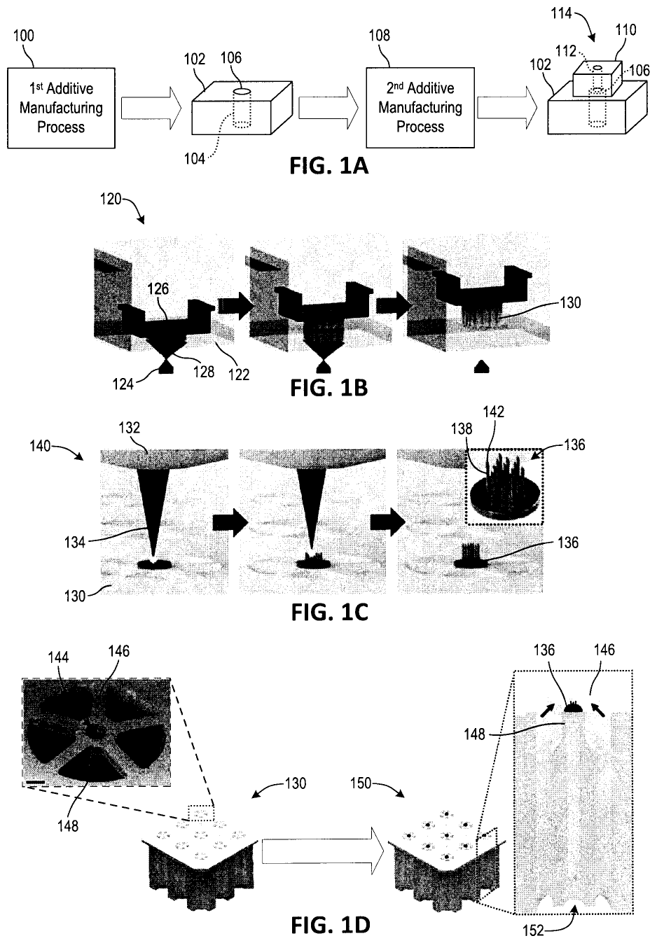

Disclosed herein are methods and systems for multi-modality additive manufacturing of microfluidic systems, as well as microfluidic systems formed thereby. In some embodiments, separate additive manufacturing modalities can be used to fabricate different structures of the microfluidic system. For example, as shown in FIG. 1A, a first additive manufacturing modality 100 can be used to form a first structure 102. In some embodiments, the first structure 102 can include a first conduit 104 (also referred to herein as channel or lumen) and a fluidic port 106 (e.g., an input or output port) in fluid communication with the first conduit 104. In some embodiments, the first structure 102 can also have an externally-accessible fluidic port in fluid communication with the first conduit 104, for example, to function as a macroscale-to-microscale interface for the microfluidic system 114. Although only a single conduit 104 and fluidic port 106 is shown in FIG. 1A, multiple conduits and/or ports in the first structure 102 are also possible according to one or more contemplated embodiments.

A second additive manufacturing modality 108 can be used to form a second structure 110 on the first structure 102. In some embodiments, the first additive manufacturing modality 100 can have a higher print speed and/or be more cost effective than the second additive manufacturing modality 108. Alternatively or additionally, in some embodiments, the second additive manufacturing modality 108 can offer minimum feature sizes (e.g., ≤1 μm) less than that offered by the first additive manufacturing modality 100. For example, the second additive manufacturing modality 108 can comprise ex situ direct laser writing (esDLW), and the first additive manufacturing modality 100 can comprise a vat photopolymerization process.

In some embodiments, the second structure 110 can be formed directly on and integrated with (e.g., fluidically sealed to) the first structure 102, thereby forming the microfluidic system 114. In some embodiments, the second structure 110 can have a second conduit 112, which can be formed in fluid communication with the fluidic port 106 of the first structure 102. For example, the second structure 110 can have features (e.g., conduit 112) with microscale dimensions (e.g., ≤500 μm). Although only a single conduit 112 is shown in FIG. 1A, multiple conduits and/or ports in the second structure 110 are also possible according to one or more contemplated embodiments.

### Microfluidic Systems

In some embodiments, the second structure can comprise and/or be formed as, for example, one or more needles (e.g., microneedle array), one or more actuators (e.g., a soft robotic actuator), one or more channels (e.g., microvessels for biological cell growth or study), or any combination of the foregoing. For example, FIGS. 1B-1D illustrate aspects of multi-modality additive manufacturing of a microfluidic system with a microneedle array (MNA) formed directly on a fluidic connector (also referred to herein as tube or capillary) in an array of fluidic connectors. In some embodiments, a batch array 130 of capillaries can be fabricated using a vat photopolymerization process 120, for example, as shown in FIG. 1B. In the illustrated example, a light source 124 (e.g., UV laser, arc lamp, DLP projector, LCD screen, etc.) directs patterned light 128 onto liquid-phase photocurable material 122 (e.g., resin) to form a layer on build platform 126 of cured photomaterial, with sequential layers of the capillary array 130 being formed by raising or lowering build platform 126 and repeating the patterned light exposure.

The geometric control afforded by the photopolymerization process 120 (e.g., DLP 3D printing) can allow for each capillary to be designed with a variable OD, for example, to match the dimensions of the capillary base 152 to those of the desired injector system. This capillary-specific geometric customization capability obviates the need for additional fluidic adapters and/or sealants (e.g., glues) often required to couple the mesoscale capillaries to macroscale fluidic equipment (e.g., injector systems). The outer dimensions (e.g., perimeter) of the batch array 130 can also be designed to support facile loading into the DLW 3D printer, which can eliminate, or at least reduce, the time, labor, and costs associated with manufacturing and employing custom-built capillary holders typically needed for esDLW approaches. The ability to print all of the capillaries 148 in predefined array locations with uniform surface positions and rotational orientations can address deficiencies associated with the conventional use of custom-built capillary holders that rely on undesired manual (e.g., by hand and/or eye) alignment protocols for each individual capillary. In some embodiments, each capillary 148 can be retained to the other capillaries in the batch array by one or more support members 146, which support members 146 can be selectively detached (e.g., broken or severed) to release a particular MNA-capillary assembly from the fabricated array 150 for subsequent use.

In some embodiments, MNAs 136 of hollow microneedles 138 (e.g., having a respective bore or outlet 142) can be fabricated on the capillaries in the batch array 130 using esDLW 140, for example, as shown in FIG. 1C. In the illustrated example, an objective lens 132 focuses femtosecond IR laser pulses 134 to polymerize the photomaterial disposed on the batch array 130. In contrast to conventional fabrication techniques, printing MNAs directly onto fluidic connectors (e.g., over an outlet port 144 of capillary 144 of the first structure) can overcome interface-associated barriers to MNA utility. In some embodiments, the MNAs can be fabricated with hollow, high aspect-ratio (e.g., ≥10) microneedles with microscale ODs (e.g., ≤100 μm) and high array densities (e.g., ≤100 μm needle-to-needle spacing) relevant to various microinjection applications, such as the delivery of therapeutic fluidic payloads directly into brain tissue.

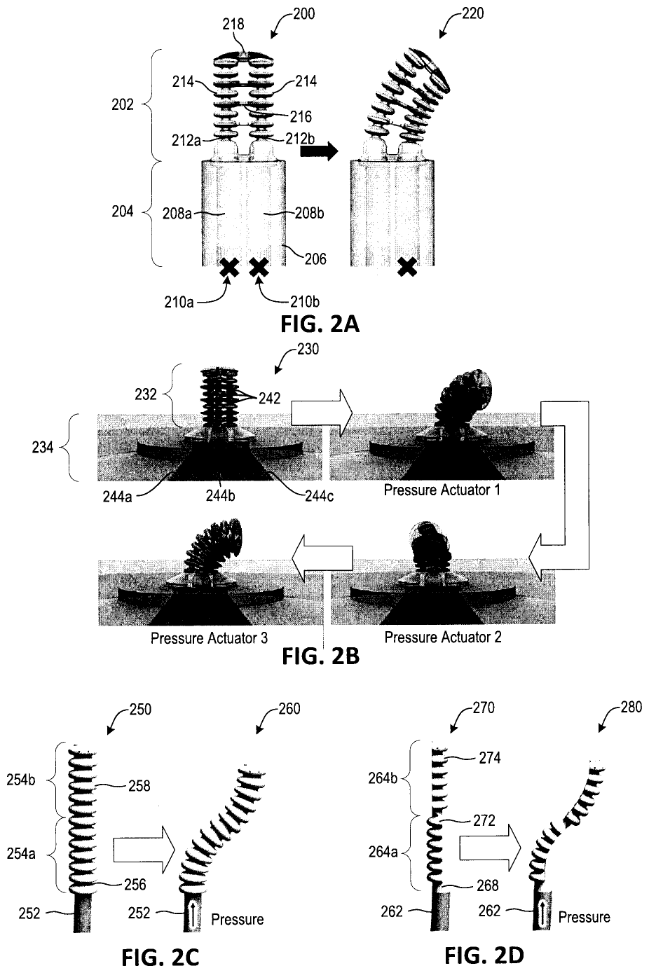

In some embodiments, a microfluidic system 200 can be constructed as a bidirectional soft robotic actuator, for example, as shown in FIG. 2A. The microfluidic system 200 can comprise a first structure 204 (e.g., formed by a vat photopolymerization process) and a second structure 202 (e.g., formed by esDLW). In the illustrated example, the first structure 204 comprises a tube 206 with separate lumina 208a, 208b extending therethrough and having respective externally-accessible ports 210a, 210b, and the second structure 202 comprises a parallel arrangement of conduits 212a, 212b, with bellows 214 serially arranged thereon and fluidically connected thereto. Within the second structure 202, the parallel arrangement of conduits 212a, 212b can be laterally connected together by one or more connection portions 216, as well as by a tip portion 218 (e.g., rounded and/or disk shaped) at a distal end of the second structure 202. Each conduit 212a, 212b of the second structure 202 can be formed on and scaled to a respective lumina 208a, 208b of the first structure 204. By applying pressure (e.g., via fluid or gas) to one of the ports 210a, 210b (or by applying a pressure differential between the ports 210a, 210b), the bellows 214 along the respective conduit can expand, thereby causing the actuator to bend away from the applied pressure port, for example, to the right for pressure applied to the left port 210a in the actuated state 220 illustrated in FIG. 2A.

Although FIG. 2A shows two actuators (e.g., two conduits 212a, 212b and two lumina 208a, 208b), other numbers of actuators are also possible according to one or more contemplated embodiments. For example, FIG. 2B shows a microfluidic system 230 with three actuators to provide omnidirectional actuation. The microfluidic system 230 can comprise a first structure 234 (e.g., formed by a vat photopolymerization process) and a second structure 232 (e.g., formed by esDLW). In the illustrated example, the first structure 234 comprises a chip with separate lumina 244a, 244b, 244c therein and having respective externally-accessible ports, and the second structure 232 comprises a parallel arrangement of three actuator arms 242 (e.g., similar to the pair of actuators in FIG. 2A) Similar to the operation of the microfluidic system 200 of FIG. 2A, the configuration (e.g., bending) of the microfluidic system 230 2B can be controlled by applying pressure (e.g., via fluid or gas) to one of the lumina 244a, 244b, 244c (or by applying pressure differential between the lumina), as shown in FIG. 2B.

Although FIGS. 2A-2B show parallel arrangements of actuators in the second structure and separate lumina in the first structure for actuation, a serial arrangement and/or single actuation lumen are also possible according to one or more contemplated embodiments. For example, FIG. 2C shows a microfluidic system 250 employing a serial arrangement of actuators. The microfluidic system 250 can comprise a first structure 252 (e.g., formed by a vat photopolymerization process) and a second structure (e.g., formed by esDLW) forming symmetric actuator segments 254a, 254b. In the illustrated example, the first structure 252 comprises a tube with a single lumen therein and having an externally-accessible port, and a single conduit 256 extends through each actuator segment 254a, 254b with bellows 258 serially arranged thereon and fluidically connected thereto. In some embodiments, the bellows 258 in each of the actuator segments 254a, 254b can be constructed to bend in opposite directions when pressurized. Thus, by applying pressure (e.g., via fluid or gas) to the lumen of the first structure 252, the bellows 258 along conduit 256 can expand, thereby causing the actuator segments 254a, 254b to form a multi-bend or S-shape, as shown by the actuated state 260 of FIG. 2C.

FIG. 2D shows another microfluidic system 270 employing a serial arrangement of actuators. The microfluidic system 270 can comprise a first structure 262 (e.g., formed by a vat photopolymerization process) and a second structure (e.g., formed by esDLW) forming asymmetric actuator segments 264a, 264b. In the illustrated example, the first structure 262 comprises tube with a single lumen therein and having an externally-accessible port, and a single conduit 268 extends through each actuator segment 264a, 264b with half bellows 272, 274 serially arranged thereon and fluidically connected thereto. In some embodiments, the opposite orientation of the half bellows 272, 274 in actuator segments 264a, 264b can cause the segments to bend in opposite directions when pressurized. Thus, by applying pressure (e.g., via fluid or gas) to the lumen of the first structure 262, the half bellows 272, 274 along conduit 268 can expand, thereby causing the actuator segments 264a, 264b to form a multi-bend or S-shape, as shown by the actuated state 280 of FIG. 2D.

Although the examples of FIGS. 2A-2D was inspired by particular applications of remotely steerable guidewires, the teachings of the present disclosure can be readily extended to additional soft robotic surgical tools for endovascular interventions. For example, the designs of the first and second structures can be constructed to realize steerable microcatheters and soft robotic biopsy instruments at unprecedented sizes. Such developments would hold distinctive potential by bridging an important need in minimally invasive surgery, facilitating entirely new classes of fluidically actuated soft robotic surgical tools suitable for small, complex, tortuous, and/or delicate vasculature.

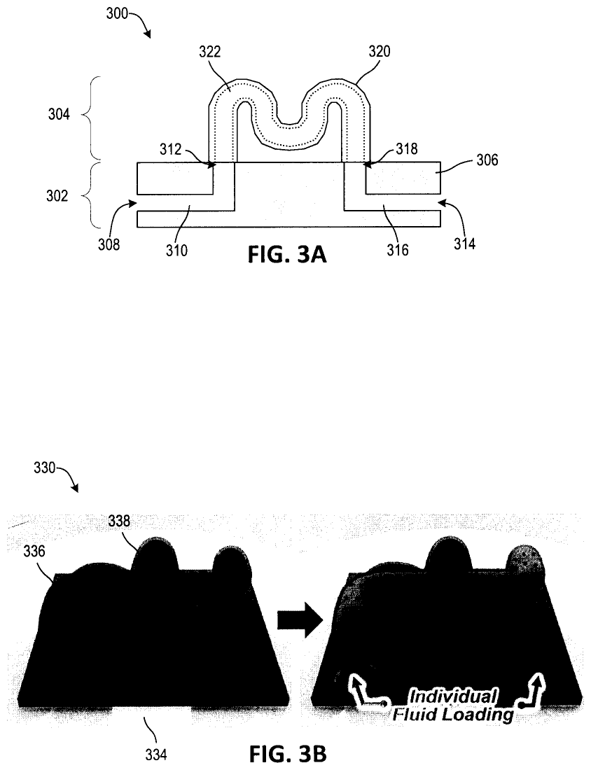

In some embodiments, a microfluidic system 300 can be constructed as a microphysiological system, for example, as shown in FIG. 3A. The microfluidic system 300 can comprise a first structure 302 (e.g., formed by vat photopolymerization process) and a second structure 304 (e.g., formed by esDLW). In the illustrated example, the first structure 302 comprises a microfluidic chip 306 with separate lumina 310, 316 and ports 308, 312, 314, and 318, and the second structure 304 comprises a microvessel structure 320 with internal conduit 322. The first lumina 310 fluidically connects externally accessible fluidic port 308 and fluidic port 312, and the second lumina 316 fluidically connects externally accessible fluidic port 314 and fluidic port 318. The microvessel structure 320 can be formed on and sealed at opposite ends thereof to fluidic ports 312, 318 of the microfluidic chip 306. Fluid can thus be introduced to and/or extracted from the microvessel structure 320 via the externally accessible ports 308, 314 of the chip 306, for example, to seed the microvessel structure 320 with biological cells.

Although FIG. 3A shows a single microvessel structure having an undulating or serpentine shape, different microvessel shapes and/or numbers of microvessels are also possible according to one or more contemplated embodiments. For example, FIG. 3B shows a microfluidic system 330 with two intertwined vessel structures 336, 338 formed on and fluidically sealed to a microfluidic chip 334. Other configurations are also possible according to one or more contemplated embodiments.

### Fabrication of Microfluidic Systems

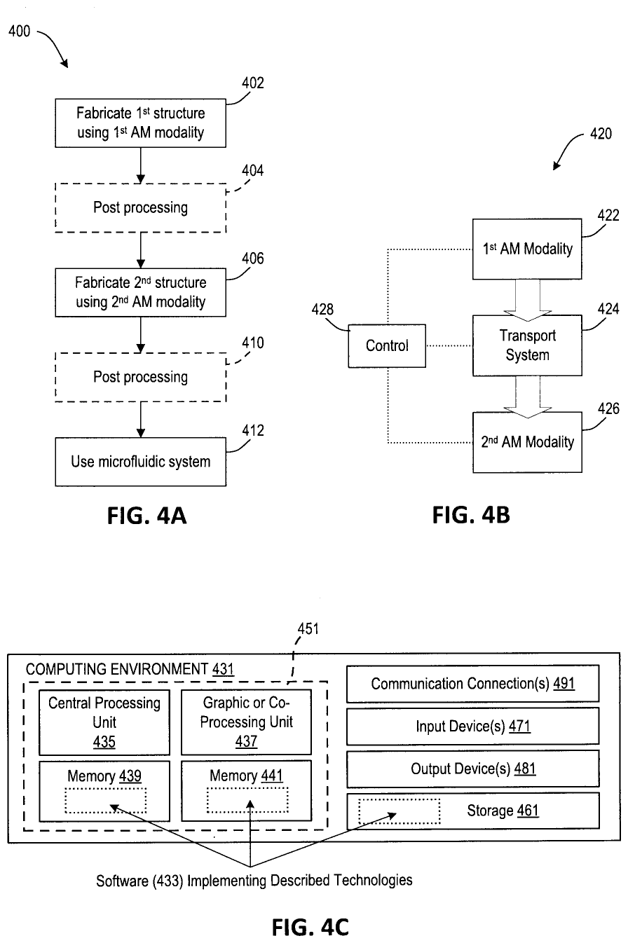

FIG. 4A shows a method 400 for fabricating a microfluidic system using multiple additive manufacturing modalities. The method can initiate at process block 402, where a first structure of the microfluidic system can be formed by a first additive manufacturing modality. In some embodiments, the first additive manufacturing modality can employ a vat photopolymerization process, such as but not limited to stereolithography, DLP 3D printing, and LCD 3D printing. In some embodiments, the first structure can function as a macroscale-to-microscale interface to subsequently formed microscale structures.

The method 400 can proceed to process block 404, where the first structure can be subjected to optional post-processing, for example, to prepare the first structure for subsequent processing. In some embodiments, the post-processing of process block 404 can include, but is not limited to, removing residual resin (e.g., via methanol perfusion), washing (e.g., with isopropyl alcohol (IPA) and/or deionized (DI) water), drying (e.g., in ambient air and/or with an inert gas flow), curing (e.g., under UV light), or any combination of the foregoing.

The method 400 can proceed to process block 406, where a second structure of the microfluidic system can be formed on the first structure by a second additive manufacturing modality. In some embodiments, the second additive manufacturing modality can employ esDLW, for example, such that the second structure is formed directly on and sealed to the first structure. In some embodiments, the second structure can function as a microscale functional device, for example, to interact with a biological system and/or function as a microphysiological system. For example, the second structure can comprise one or more needles, one or more actuators, and/or one or more channels.

The method 400 can proceed to process block 410, where the microfluidic system, or at least the second structure thereof, can be subjected to optional post-processing, for example, to prepare the microfluidic system for subsequent use. In some embodiments, the post processing of process block 410 can include, but is not limited to removing residual resin, washing, drying, curing, or any combination of the foregoing. In some embodiments, the post-processing of process block 410 can be the same as or different from the post-processing of process block 404. Alternatively or additionally, in some embodiments, the post-processing of process block 410 can include mechanically modifying or actuating part of the microfluidic system, for example, to remove a single tube (with corresponding second structure thereon) from an array of tubes forming the first structure.

The method 400 can proceed to process block 412, where the microfluidic system can be used or prepared for use. For example, the first structure of the microfluidic system can be coupled to a fluid source (e.g., injector) in preparation for conveying a substance into and/or through the second structure. Alternatively or additionally, the first structure of the microfluidic system can be coupled to a pressure source in preparation for actuating an actuator of the second structure. Alternatively or additionally, the second structure can be inserted into a target material (e.g., tissue) in preparation for injection. In some embodiments, one or more channels in the second structure can be seeded with cells, for example, for use as a microphysiological system.

Although blocks 402-412 of method 400 have been described as being performed once, in some embodiments, multiple repetitions of a particular process block may be employed before proceeding to the next decision block or process block. In addition, although blocks 402-412 of method 400 have been separately illustrated and described, in some embodiments, process blocks may be combined and performed together (simultaneously or sequentially). Moreover, although FIG. 4A illustrates a particular order for blocks 402-412, embodiments of the disclosed subject matter are not limited thereto. Indeed, in certain embodiments, the blocks may occur in a different order than illustrated or simultaneously with other blocks. In some embodiments, method 400 can include steps or other aspects not specifically illustrated in FIG. 4A or otherwise described above. Alternatively or additionally, in some embodiments, method 400 may comprise only some of blocks 402-412 of FIG. 4A or described aspects thereof.

FIG. 4B illustrates an exemplary system 420 for fabricating a microfluidic system using multiple additive manufacturing modalities. In the illustrated example, system 420 includes a first additive manufacturing modality 422, a second additive manufacturing modality 426, and a control system 428. As described above and elsewhere herein, the first additive manufacturing modality 422 can be used to form the first structure of the microfluidic system, while the second additive manufacturing modality 426 can be used to form the second structure of the microfluidic system on the first structure. For example, the first additive manufacturing modality 422 can comprise a vat photopolymerization process, and the second additive manufacturing modality 426 can comprise esDLW.

Since the first structure formed by the first additive manufacturing modality 422 serves as the substrate upon which the second structure is formed by the second additive manufacturing modality 426, the first structure can be conveyed from the first additive manufacturing modality 422 to the second additive manufacturing modality 426, for example, using an optional transport system 424. In some embodiments, the transport system 424 can include conveyor belts, robotic manipulators, vacuum devices, or any components capable of moving the first structure from the first additive manufacturing modality 422 and/or positioning the first structure within the second additive manufacturing modality 426 in an aligned orientation. Alternatively or additionally, the first structure can be manually moved from the first additive manufacturing modality 422 and/or to the second additive manufacturing modality 426.

Control system 428 can be operatively coupled to the various components of the fabrication system 420 and can be configured to control operations thereof (e.g., to coordinate respective forming of the first and second structures). Although illustrated as a single unit, in some embodiment, the control system 428 can include separate control devices for each modality 422, 426 and/or transport system 424.

### Computer Implementation Examples

FIG. 4C depicts a generalized example of a suitable computing environment 431 in which the described innovations may be implemented, such as but not limited to aspects of fabrication method 400 and/or control system 428. The computing environment 431 is not intended to suggest any limitation as to scope of use or functionality, as the innovations may be implemented in diverse general-purpose or special-purpose computing systems. For example, the computing environment 431 can be any of a variety of computing devices (e.g., desktop computer, laptop computer, server computer, tablet computer, etc.).

With reference to FIG. 4C, the computing environment 431 includes one or more processing units 435, 437 and memory 439, 441. In FIG. 4C, this basic configuration 451 is included within a dashed line. The processing units 435, 437 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 4C shows a central processing unit 435 as well as a graphics processing unit or co-processing unit 437. The tangible memory 439, 441 may be volatile memory (e.g., registers, cache, RAM), non-volatile memory (e.g., ROM, EEPROM, flash memory, etc.), or some combination of the two, accessible by the processing unit(s). The memory 439, 441 stores software 433 implementing one or more innovations described herein, in the form of computer-executable instructions suitable for execution by the processing unit(s).

A computing system may have additional features. For example, the computing environment 431 includes storage 461, one or more input devices 471, one or more output devices 481, and one or more communication connections 491. An interconnection mechanism (not shown) such as a bus, controller, or network interconnects the components of the computing environment 431. Typically, operating system software (not shown) provides an operating environment for other software executing in the computing environment 431, and coordinates activities of the components of the computing environment 431.

The tangible storage 461 may be removable or non-removable, and includes magnetic disks, magnetic tapes or cassettes, CD-ROMs, DVDs, or any other medium which can be used to store information in a non-transitory way, and which can be accessed within the computing environment 431. The storage 461 can store instructions for the software 433 implementing one or more innovations described herein.

The input device(s) 471 may be a touch input device such as a keyboard, mouse, pen, or trackball, a voice input device, a scanning device, or another device that provides input to the computing environment 431. The output device(s) 481 may be a display, printer, speaker, CD-writer, or another device that provides output from computing environment 431.

The communication connection(s) 491 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

### Example(s) 1: Microneedle Arrays

Microinjection technologies underlie a diversity of biomedical applications, such as in vitro fertilization, intraocular injection, therapeutic drug and vaccine delivery, developmental biology, and transgenics. Microinjection protocols have historically relied on using a single hollow microneedle to deliver target substances (e.g., biological cells, DNA, RNA, micro/nanoparticles) to a singular location of interest, for example, in stem cell therapy (SCT). An obstacle to the clinical efficacy of SCT is the poor viability of stem cells following delivery into the host tissue (e.g., brain). For example, the single microneedle can lead to cell crowding at the injection site from high concentrations of donor cells (e.g., up to 100,000 cells/μL), which can lead to large cell spheroids with undesirable conditions (e.g., decreased access to O₂ and nutrients for interior cells) that contribute to the low survival rates of implanted stem cells. The use of microneedle arrays (MNAs) for microinjection protocols can address this issue, for example, by rapidly delivering target substances over a larger distributed area, which can be beneficial for transdermal and intradermal drug delivery. The simultaneous, distributed cell delivery via MNAs could provide novel means to improve cell survival rates by reducing cell crowding. Ot penetrate into tissues of interest for therapeutics delivery, the microneedles of the MNA can each have outer diameters on the order of tens of microns (e.g., 10-100 μm) and heights (length along an axial direction thereof) of at least 500 μm.

To fabricate MNAs while providing macro-to-microinterfaces (e.g., input ports), a novel hybrid additive manufacturing strategy was developed. First, digital light processing (DLP) 3D printing was used to fabricate batches of tubes (e.g., capillaries) in set positions. The capillary batch was then used as a substrate upon which the MNAs can be formed, in particular, by using ex situ direct laser writing (esDLW) to print hollow, high-aspect-ratio, high-density MNAs directly onto and fluidically sealed to the DLP-printed capillaries. Thereafter, individual MNA-capillary assemblies can be selectively released by disrupting the connections to the batch and then interfaced with injector systems for microinjection applications.

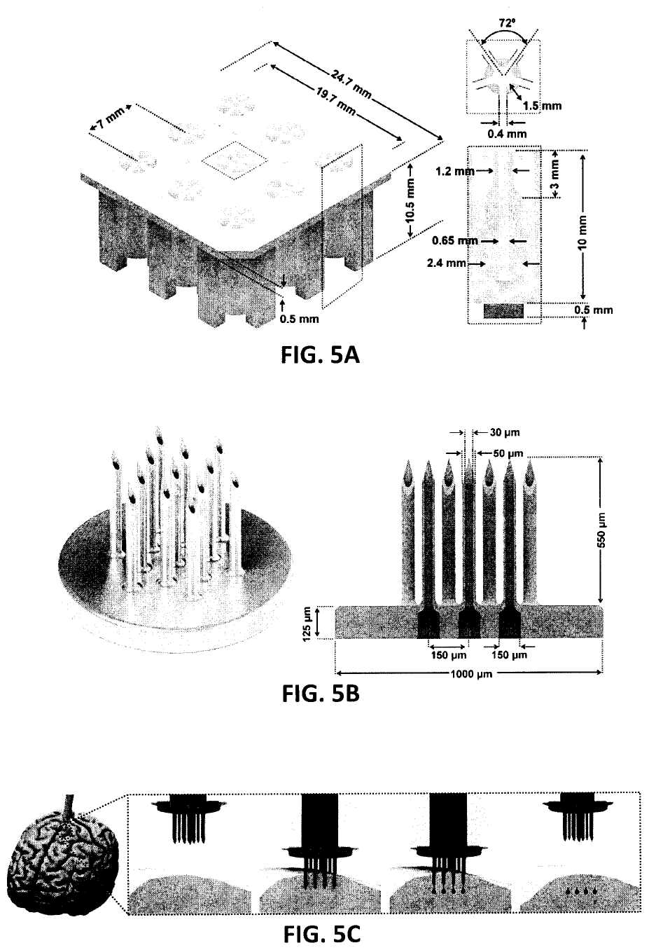

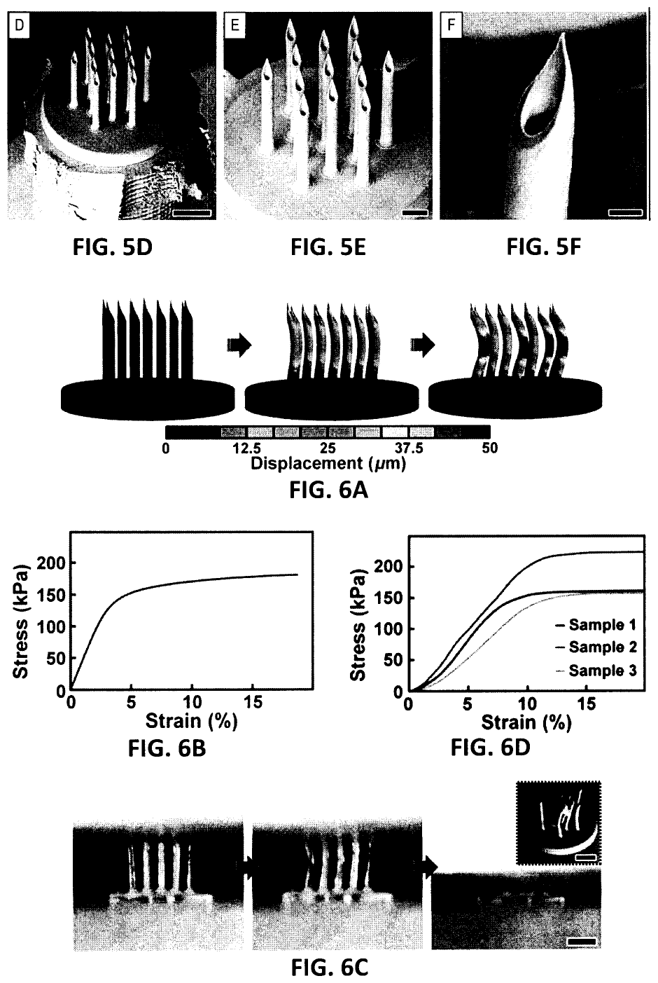

Batch capillary arrays (9 tubes) were printed using a digital light processing (DLP) 3D-printing modality (Miicraft M50 microfluidics DLP 3D printer, sold by CADworks3D, Toronto, ON, Canada), with the layer height set to 50 μm. To enable direct integration with the nanoinjector system (MO-10, sold by Narishige International USA, Inc., Amityville, NY), each capillary was designed with a consistent inner diameter (ID) of 650 μm, but with a variable OD that was set at 1.2 mm for the top 1.5 mm and then gradually increased to 2.4 mm for the remainder of the 10 mm length of the capillary, as shown in FIG. 5A. Following the DLP printing process, the build plate was removed, and the prints were manually detached from the build plate using a razor blade. The prints were developed in methanol for ˜10 s, and then methanol was perfused through each capillary to eliminate any residual resin from the interiors. After one additional rinse with methanol, the prints were washed with 90% isopropyl alcohol (IPA). The prints were then dried with pressurized air and post-cured under UV light for 20 s (flipping the device after 10 s to cure both sides equally). Fabrication results revealed effective construction of the arrayed capillaries, with each being attached to the batch via five connecting structures (400 μm in width and depth; 1.5 mm in length). In addition, the outer dimensions of the overall batch resolved such that the print could be readily loaded into the multi-DiLL holder of the DLW system (Photonic Professional GT2, sold by Nanoscribe GmbH, Germany) to facilitate esDLW-based 3D printing.

Microneedle arrays were designed with identical needles (ID=30 μm; OD=50 μm; height=550 μm) and arrayed with 100 μm needle-to-needle spacing, as shown in FIG. 5B. MNA models were exported as STL files and then imported into the CAM software, DeScribe (Nanoscribe), to define the print parameter settings, which included a hatching distance of 800 nm and a layer height of 2.5 μm. Initially, IP-Q photoresist (Nanoscribe) was dispensed directly atop the DLP-printed capillaries and the batch was then loaded into the DLW system. For esDLW printing, the dip-in laser lithography (DiLL) mode was used with a 10× objective lens, a laser power of 27.5 mW, and a laser scanning speed of 120 000 μm/s. The printing process was initiated with 50 μm of overlap with the top capillary surfaces to ensure bonding at the interface. Following the esDLW process, the batch assembly (with MNAs printed atop the capillaries) was removed from the DLW printer for development. The prints were developed using propylene glycol monomethyl ether acetate (PGMEA) for 30 minutes and IPA for 5 minutes, and then dried using a gentle stream of N₂ gas.

For the DLP-printed capillary, the shape and size need not be uniform along the length of the capillary, as is the predominant case for conventional and/or commercially available fluidic capillaries. For instance, the OD of the base of the capillary was designed to yield facile, direct integration with the nanoinjector, thereby circumventing the need for additional fluidic adapters or sealants. Similarly, although the presented design for the esDLW-printed MNAs included identical microneedles with dimensions based on a specific exemplar (e.g., fluidic microinjection into the cerebral cortex of a mouse brain), the high architectural control and submicrometer-scale resolution of DLW can be leveraged to customize the size, shape, and position of each individual microneedle in an array as desired. For example, the microneedle heights can be changed to target different regions of the brain and/or different animal models. Conversely, while this example centered on printing hollow microneedles (with 30 μm IDs) to support fluidic delivery operations, the presented strategy could be extended to print MNAs composed of solid microneedles, such as those fabricated using DLW-compatible biodegradable materials, or potentially hybrid MNAs that comprise both hollow and solid microneedles.

The DLP-printing of the batch arrays of fluidic capillaries allowed for facile loading into the DLW 3D printer, obviating the need for custom-built capillary holders as well as the time- and labor-intensive protocols required to manually load each individual capillary into such holders. Furthermore, because each capillary is printed in a designated array position with specified orientations, the setup for initiation of the esDLW-printing process was minimized, which could provide a promising avenue to scalable and automated production. Although a layer-by-layer DLP printer was employed to manufacture the batch arrays of fluidic capillaries, other vat photopolymerization approaches could be used instead, for example, to increase production speed, such as continuous liquid interface production to print parts in minutes or various volumetric 3D printing strategies to fabricate parts in tens of seconds.

For esDLW-based printing of the MNAs, while the voxel size remained constant throughout the printing process with a scan speed of ≈120 mm/second, the size of the voxel can be tailored to target features and/or allow for faster scan speeds (e.g., up to 1,250 mm/second with a 5× objective lens configurations) in order to dramatically enhance print efficiency and speed. Moreover, the DLW printer can be adapted to print multiple MNAs simultaneously in a single pass (in contrast to the serial MNA printing employed in the fabricated examples), which would further increase the attainable production volume.

As an exemplar, the utility of the MNAs for performing microinjections into brain tissue was investigated by using excised mouse brains, as shown schematically in FIG. 5C. To use the printed microfluidic structure, individual MNA-capillary assemblies were removed from the batch by manually severing the five connecting structures arrayed radially around each capillary. As shown in the SEM images of FIGS. 5D-5F, the esDLW-printed MNAs exhibit effective alignment and integration with the DLP-printed capillaries, without any visible signs of physical defects along the MNA-capillary interface. In addition, FIGS. 5D-5F suggest that the manual release process did not appear to affect MNA integrity.

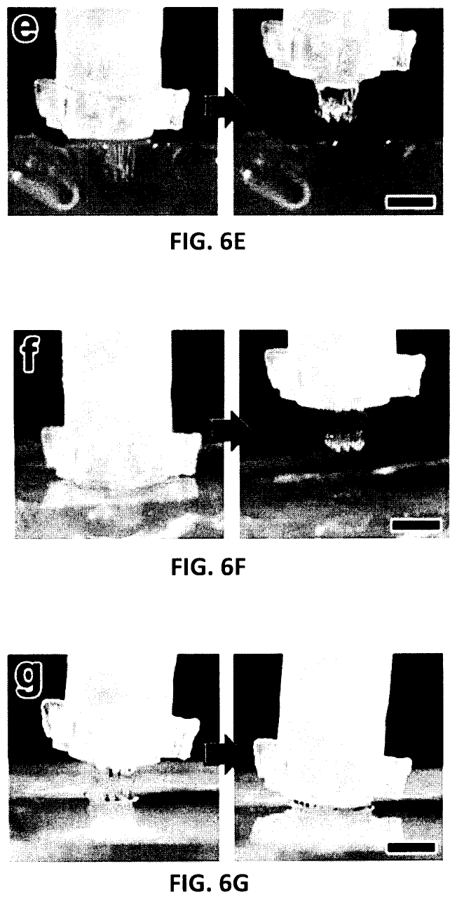

When using the MNA-capillary assembly for microinjection, the effective puncture and penetration into a target medium (e.g., biological tissue) can impart significant mechanical forces on the microneedles. Thus, the potential utility of MNAs is predicated on their ability to successfully withstand such mechanical loading conditions. To evaluate this capability for the esDLW-printed high-aspect-ratio MNAs, numerical and experimental approaches were employed to elucidate the mechanical performance of the MNAs. Finite element analyses (FEA) were performed to provide insight into the mechanical failure behavior of the MNAs when subjected to a compressive load applied longitudinally with respect to the needles. The simulation results revealed that each arrayed microneedle exhibited a buckling-like deformation with the largest displacements observed around the midpoint of the heights; however, needles positioned in the outer region (e.g., the needles radially arrayed farthest from the center of the MNA) displayed larger deformations compared to those located in the more central array positions, as shown in FIG. 6A. This behavior arises from the load distribution caused by the disc-like base of the MNA, which deforms more in its central region than its peripherical region, thereby allowing the centrally located microneedles to rigidly displace more in the axial direction than their outer-region counterparts.

According to the stress-strain curve in FIG. 6B, which was generated from the FEA compressive loading simulations, the overall MNA exhibited an effective Young's Modulus (E) of 4.31 MPa and yield strength (σ_{γ}) of 135 kPa. The MNA mechanics associated with puncture into the brain tissue were numerically modelled. By characterizing the nonlinear response at the interface between the tips of the microneedles and the brain substrate, it was found that the forces associated with the needles located in the outer region were larger than those in the central regions, which agrees with the compressive loading analyses of FIG. 6A.

To experimentally examine the mechanical performance of the esDLW-printed MNA, two sets of puncture and penetration-associated studies were conducted. First, axial compression tests were performed with esDLW-printed MNAs (n=3), which revealed buckling-type deformations of the microneedles with increasing loading until complete mechanical failure, as shown in FIG. 6C. From SEM images of MNAs following compressive testing, several cases of complete fracture were observed, but the majority of the arrayed microneedles remained intact with the caveat that the tips and the overall shapes of the needles exhibited plastic deformation (e.g., as shown in the inset of FIG. 6C). Quantified results for the stress-strain relationships for the esDLW-printed MNAs, as shown in FIG. 6D, revealed an average E of 2.12±0.35 MPa and σ_{γ} of 155±30 kPa.

Although these results provide insight into the upper boundaries of mechanical loading, compression testing using an impenetrable plate may be limited in its relevance to microinjection applications that rely on microneedle penetration into a target medium. Thus, additional testing was performed to evaluate the capacity for the esDLW-printed MNAs to puncture and penetrate into surrogate hydrogels with increasing concentrations of agarose that correspond to varying degrees of biologically relevant stiffness. In particular, experiments with agarose concentrations of: i) 1.2% (E=12.8±1.1 kPa), which would support penetration into liver and breast tissue; ii) 2.4% (E=27.5±1.0 kPa), which is relevant to brain, heart, kidney, arterial, and prostate tissue; and iii) both 5% (E=223±14 kPa) and 10% (E=268±31 kPa), which are relevant to cartilage tissues. Experimental results are shown in FIGS. 6E-6G. The MNA successfully penetrated into the 1.2%, 2.4%, and 5% agarose gels; however, buckling of the microneedles and failure to penetrate was observed for the 10% agarose gel. These results suggest that the esDLW-printed MNA is sufficient for penetration into brain tissue as well as a variety of other tissues (e.g., liver, breast, heart, kidney, arterial, and prostate tissues), but alternative photomaterials (e.g., with stronger mechanical properties) and/or microneedles with geometrically-enhanced strength (e.g., by increasing the OD) would be needed for microinjection applications involving target mediums with E in excess of 250 kPa.

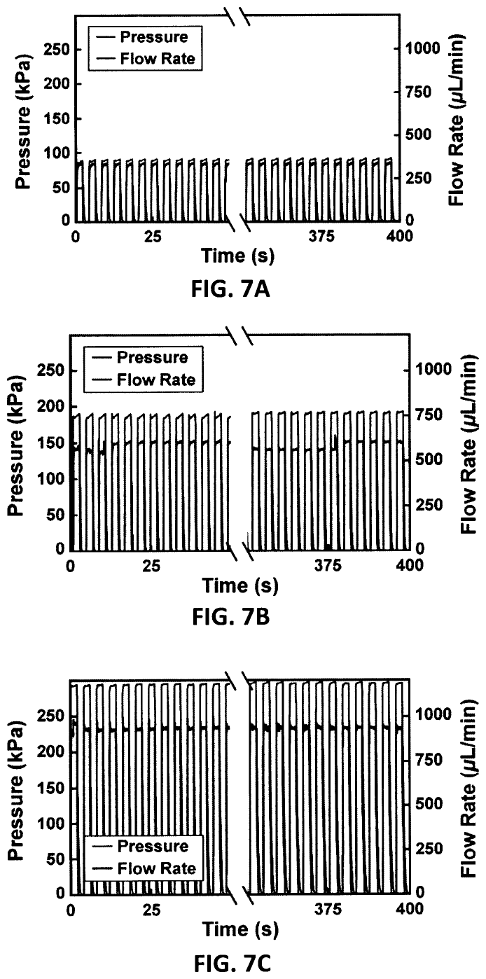

One of the most catastrophic failure modes for esDLW-based prints-whether for optical, photonic, mechanical, or fluidic structures—is the potential for the DLW-printed structures to detach from the meso/macroscale components on which they are additively manufactured. For biomedical MNA applications, the consequences of this type of failure could be particularly serious, such as an MNA detaching from the capillary while embedded in brain tissue following microinjection. To investigate the potential for this failure mode and, in turn, provide insight into the mechanofluidic integrity of the interface between the esDLW-printed MNAs and the DLP-printed capillaries, the MNA-capillary assemblies were subjected to microfluidic cyclic burst-pressure tests. Initially, using an applied pressure set at 5 kPa, blue-dyed deionized (DI) water was gradually infused into the MNA-capillary assembly via the opposing end of the capillary (i.e., the side without the printed MNA) until the fluid began exiting the tips of the arrayed microneedles. Thereafter, separate sets of cyclic burst-pressure experiments (n=100 cycles per experiment) were performed, corresponding to applied pressures set at 100, 200, and 300 kPa, the results of which are shown in FIGS. 7A-7C, respectively. Throughout the burst-pressure testing, monitored the MNA-capillary interface was monitored under brightfield microscopy for visible signs of undesired leakage phenomena (e.g., fluid exiting at any point along the interface rather than out of the tops of the microneedle tips); however, such undesired flow behavior was not observed during any of the experiments. Similarly, quantified results of fluid flow through the MNA-capillary assembly recorded during the burst-pressure tests did not exhibit any indications of burst events (e.g., large increases in flow rates after a certain point, despite the applied pressure remaining constant), nor signs of gradual leakage phenomena associated with the flow rates increasing from pressure cycle to pressure cycle over the course of the experiment. Rather, the flow rate magnitudes corresponding to the applied input pressures remained consistent throughout the burst-pressure experiments, as shown in FIGS. 7A-7C, suggesting uncompromised fluidic integrity of the MNA-capillary interface for all cases examined.

As an exemplar with which to interrogate the penetration, microinjection, and retraction capabilities of the esDLW-printed MNAs, brains with intact dura mater were excised from euthanized 6-month-old male mice (Wildtype C57BL/6 J, Jackson Laboratory) for experimentation ex vivo. Three sets of experiments were performed to elucidate these fundamental MNA functionalities. The ability to execute penetration and retraction operations (but not fluidic microinjections) with the MNAs was investigated with respect to three potential failure modes that could limit the efficacy of the esDLW-printed MNAs: i) the sharpness of the tips of the microneedles-governed by the resolution of the DLW 3D printer—was insufficient to puncture the brain tissue without inducing significant deformation of the brain; ii) the mechanical properties of the high-aspect-ratio microneedles led to buckling and/or fracture of the microneedles prior to effective penetration into the brain tissue; and/or iii) the forces during the penetration or retraction processes fractured the microneedles, causing microneedles (or fragments of microneedles) to remain embedded in the brain tissue after completion of retraction. To facilitate the penetration and retraction studies, each MNA-capillary assembly examined was interfaced with a nanoinjector system fixed to a stereotactic frame as a means to enable precise position control while optically monitoring the MNA-brain tissue interactions.

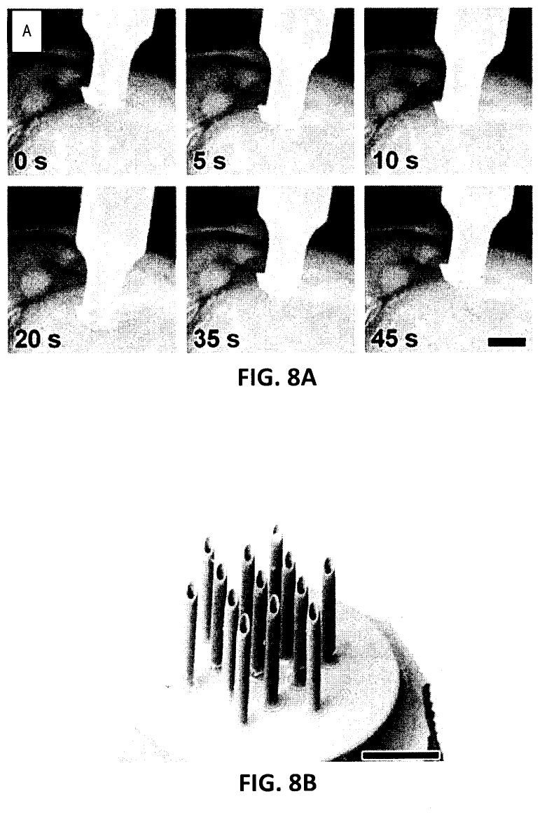

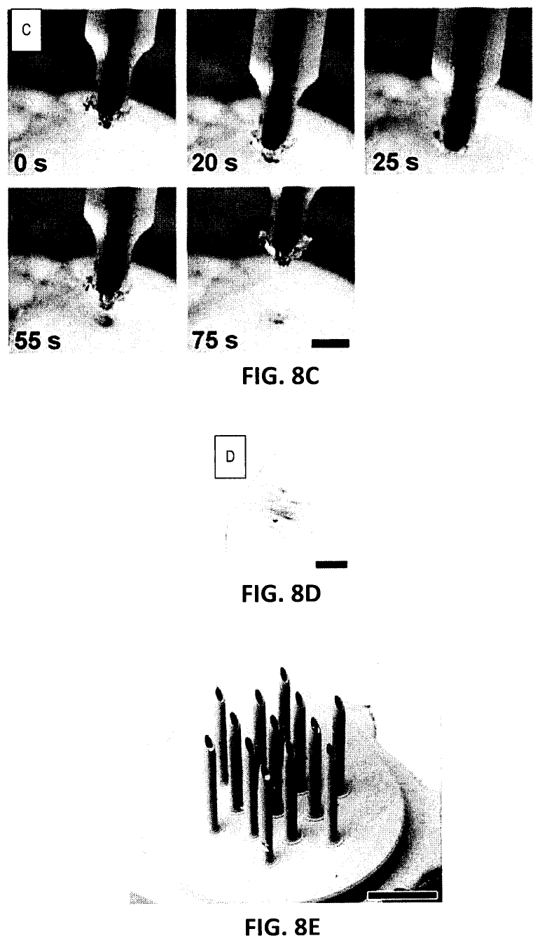

Experiments were performed with three distinct MNA-capillary assemblies (n=3 penetration and retraction operations for each distinct MNA-capillary assembly) revealed that the MNAs could successfully puncture the brain tissue within 1 mm of total displacement from initial contact and, importantly, without any visible signs of mechanical failure during any of the penetration or retraction operations, as shown in FIG. 8A, and without any indications of microneedle-associated failure modes (e.g., buckling or fracture) or MNA detachment from the capillary, as shown in FIG. 8B. After validating the penetration and retraction capabilities, the microinjection functionality of the MNAs was evaluated based on the ability to deliver a surrogate microfluidic payload into the brain tissue. In this case, the MNA-capillary assembly was preloaded with blue-dyed (1.5% Evan's Blue) DI water, and interfaced with the nanoinjector for control of both the MNA position and fluidic microinjection dynamics. Although the results for the previously-performed cyclic microfluidic burst-pressure experiments suggested that the MNA-capillary interface should withstand the forces associated with microinjections into the brain tissue, the overall MNA-capillary assembly was optically monitored during the microinjection process for potential signs of undesired leakage via the interface. The stereotaxic frame was used to guide the descent of the MNA into the brain tissue, as shown in FIG. 8C. Following completion of the penetration process, the pneumatically controlled nanoinjector was used to dispense the surrogate dyed fluid through the MNA-capillary assembly and, in turn, deliver the fluid into the brain tissue. The MNA was then retracted from the brain tissue, and the surface of the injection site was washed with phosphate buffered saline (PBS) to eliminate any residual surrogate fluid from the surface, such that the only remaining fluid was located beneath the tissue surface. Throughout the microinjection process, undesired leakage was not observed, with optical characterizations of the post-injection site confirming effective, distributed MNA-mediated delivery of the surrogate fluid well below the surface of the excised brain, as shown in FIG. 8D. As shown in the SEM image of the MNA-capillary assembly in FIG. 8E, taken after tissue penetration, fluidic microinjection and retraction revealed uncompromised structural integrity.

The microinjection performance of the esDLW-printed MNA was compared to a conventional needle (Hamilton 33G) widely used for delivering therapeutics into brain tissue. In this case, a suspension of fluorescently labeled nanoparticles (100 nm in diameter) was used as the surrogate microfluidic payload. As an initial positive experimental control for the esDLW-printed MNA, microinjections (n=3 MNAs) of the nanoparticle suspension were made into 0.6% agarose gel in vitro, as shown in FIG. 9A. The resulting particle distributions were visualized using two-photon and widefield fluorescence microscopy, as shown in FIGS. 9B-9C, respectively. The injected nanoparticles were observed corresponding to each microneedle in the array, which included one microneedle in the center of the array, six needles arrayed radially in a middle region (150 μm from the center), and six needles arrayed radially in an outer region (260 μm from the center). To determine if microneedle array position influenced injection behavior, the fluorescence intensities associated with each arrayed needle were analyzed. The quantified results of FIG. 9D show that the fluorescence intensities were statistically indistinguishable, with no discernable difference for the microneedle injection sites between the center and either the middle (p=0.66) or outer regions (p=0.61), nor between the middle and outer regions (p=0.72).

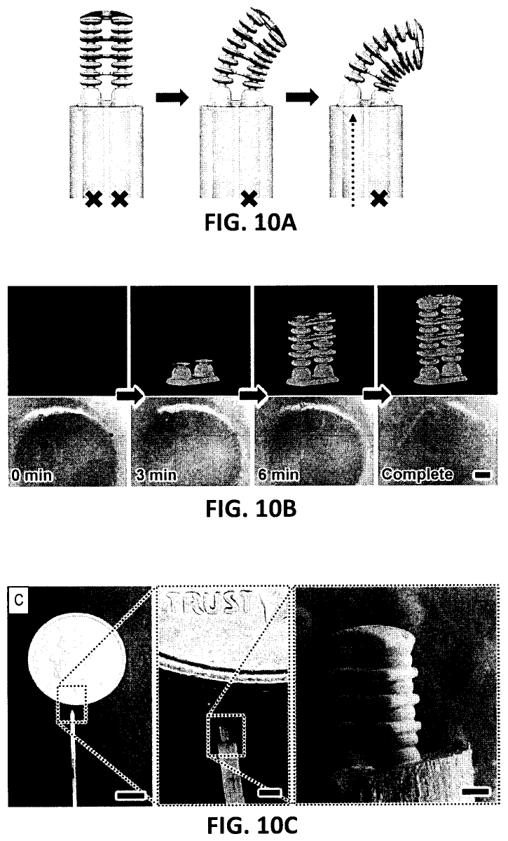

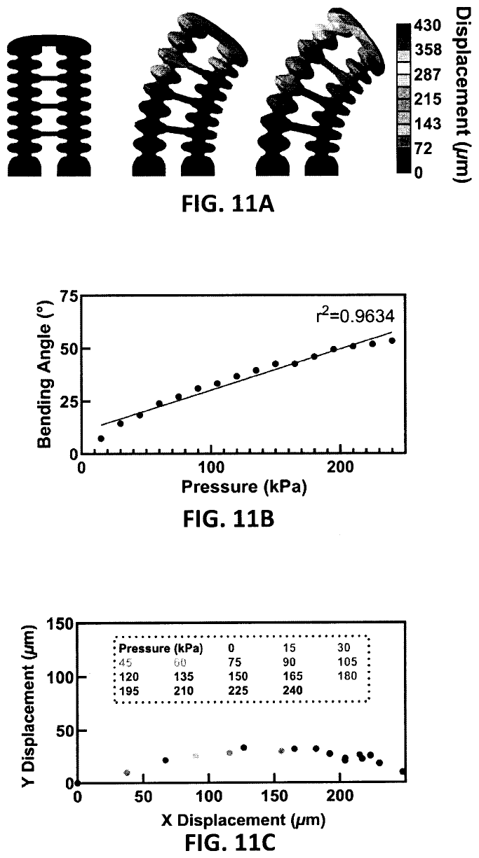

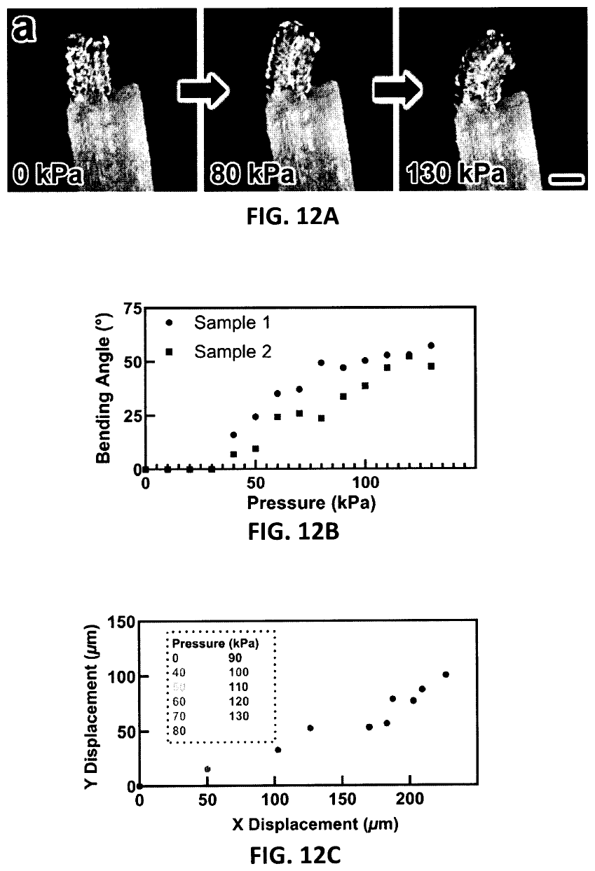

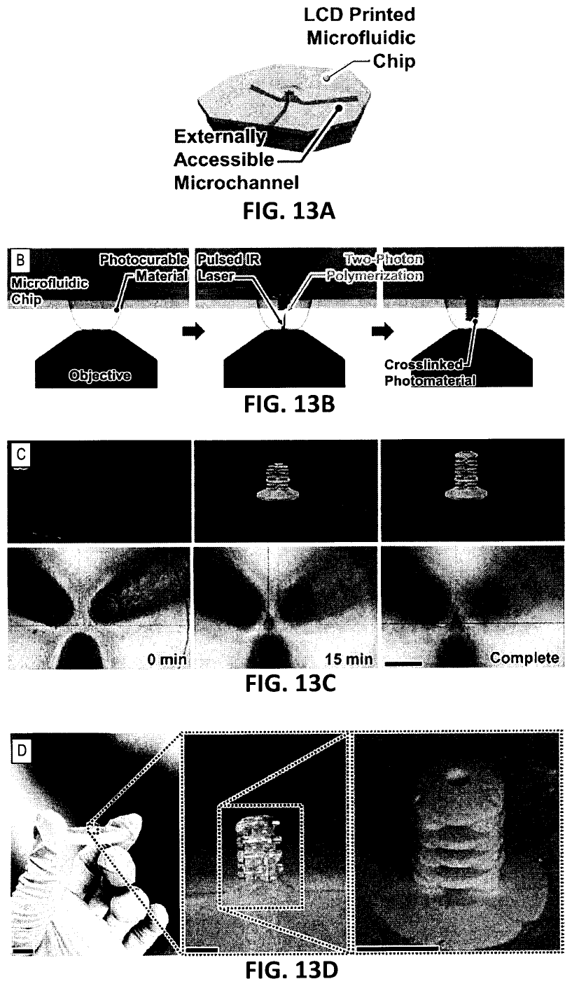

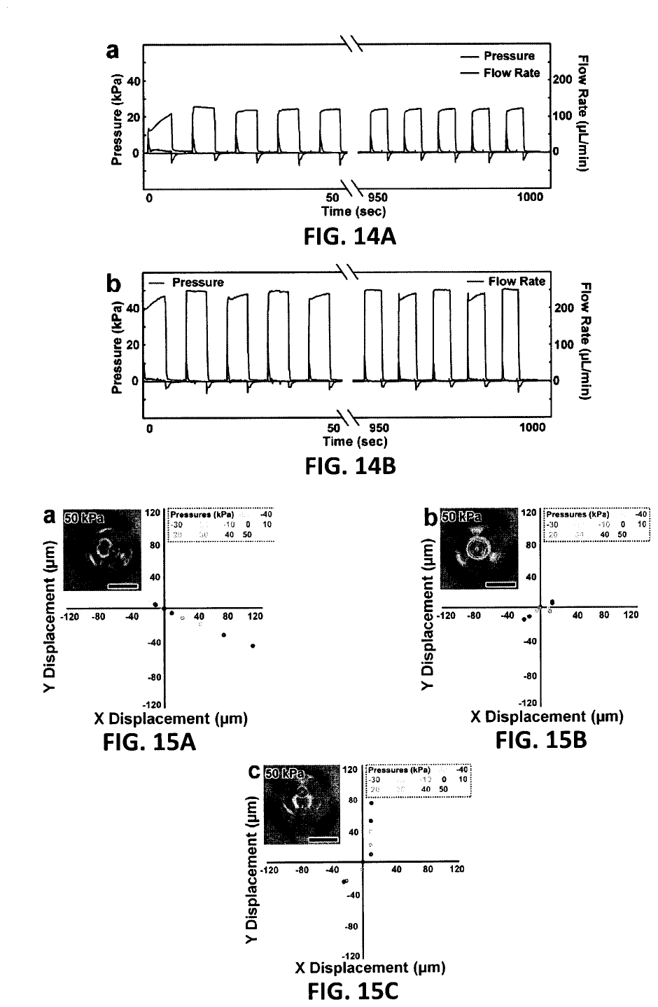

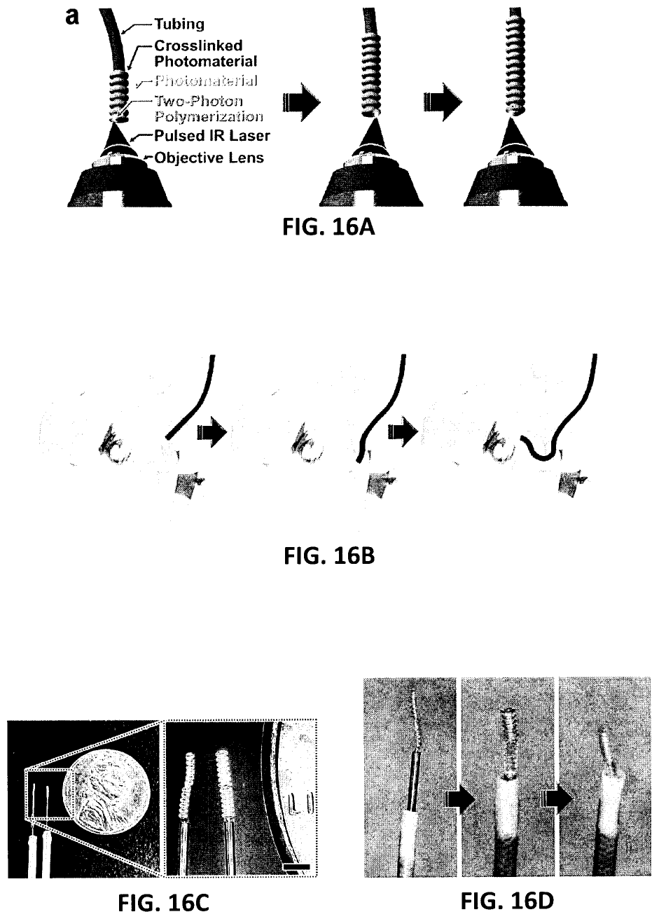

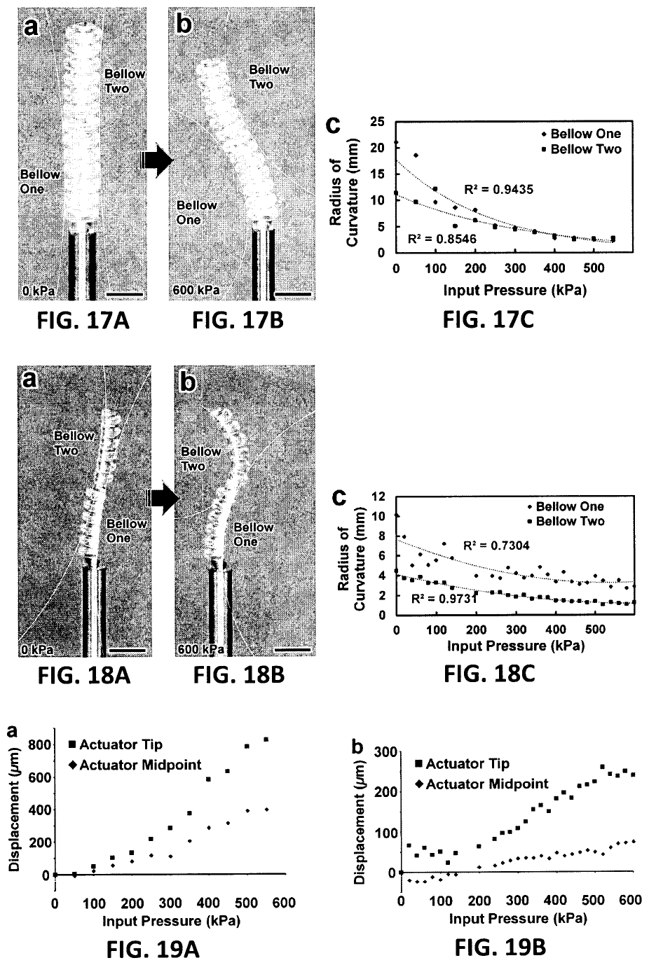

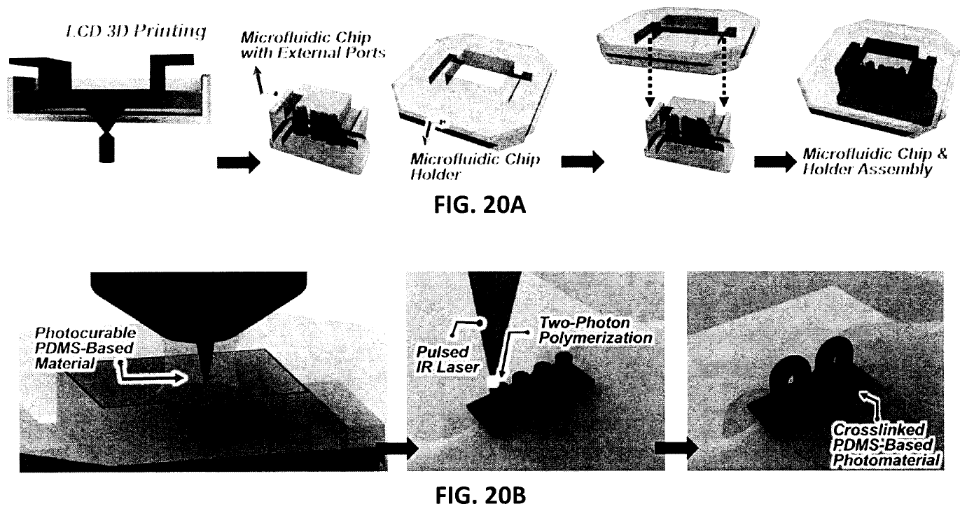

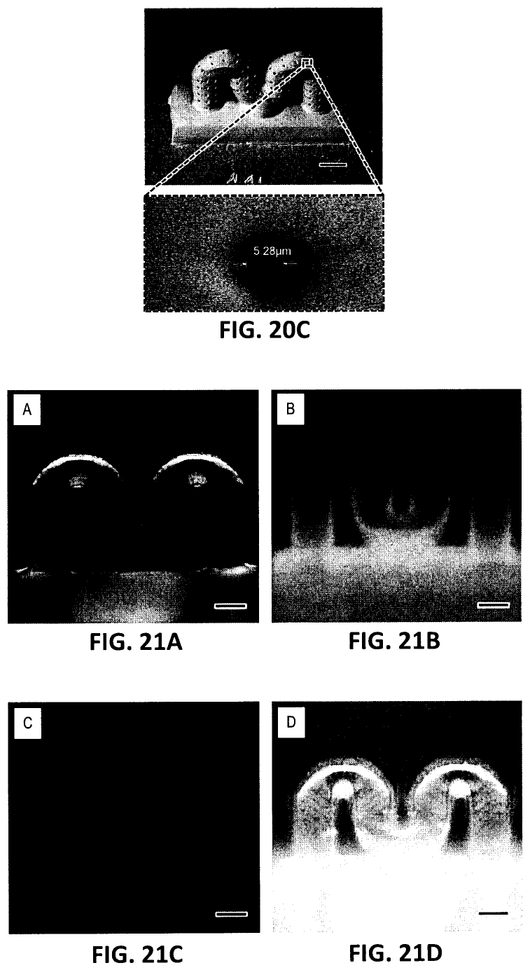

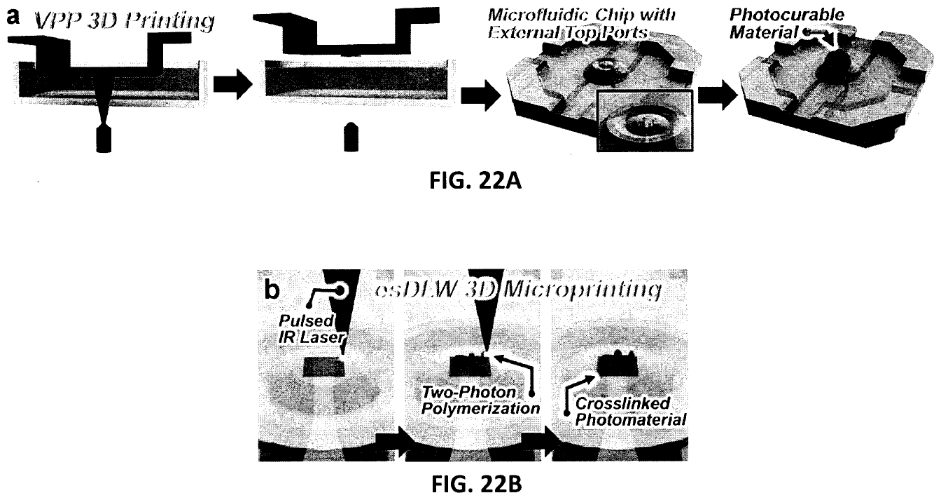

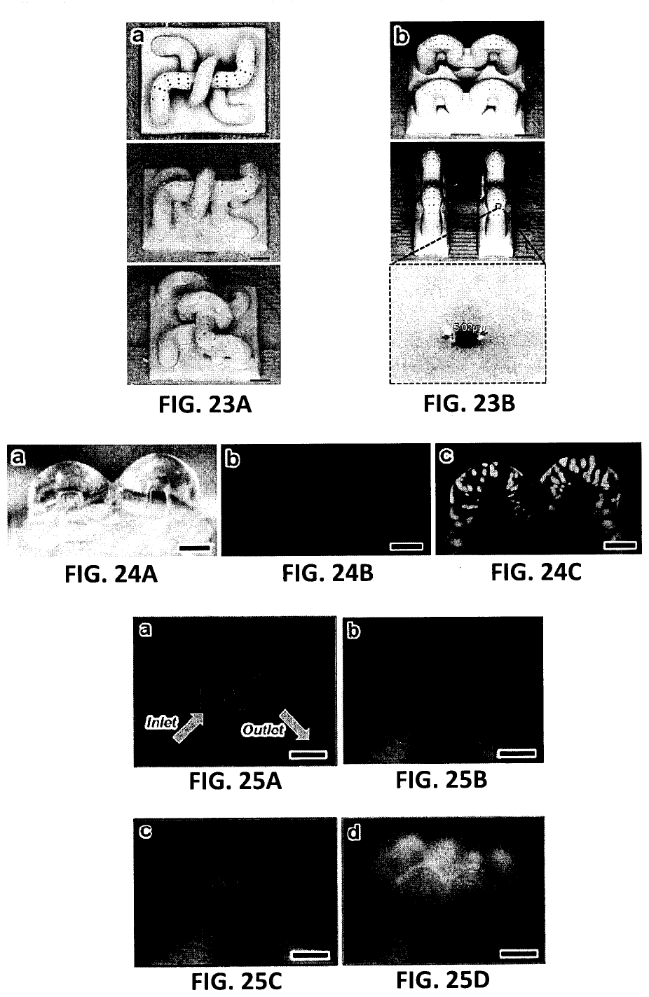

Microinjections of the nanoparticle suspension were then made into excised mouse brains using both the conventional needle and the esDLW-printed MNA, as shown in FIG. 9E. Two-photon fluorescence images of the injection sites revealed stark differences in the nanoparticle distributions associated with each needle system. In the conventional needle case, the nanoparticles accumulated tightly within the single needle track, as shown in FIGS. 9F-9G. For example, the quantified fluorescence intensity results of FIG. 9H show that the majority of the fluorescence signal was detected within an ≈150 μm region. In contrast, the MNA-associated microinjection sites exhibited a more homogeneous distribution of injected nanoparticles over a larger area, with particles detected at sites corresponding to each arrayed microneedle, as shown in FIGS. 91-9J. This resulted in a more consistent fluorescence signal along the length of the injection site, as shown in FIG. 9K. These results suggest that MNAs offer an effective means to distribute fluidic payloads more uniformly over a larger area compared to conventional single-needle systems. In combination, these experimental results for MNA penetration, surrogate fluid/suspension delivery, and retraction functionalities using an ex vivo mouse brain provide an important foundation for the utility of the presented hybrid DLP-DLW-enabled MNAs for microinjection applications.

The numerical and experimental mechanical characterizations of the esDLW-printed MNA suggest that, in addition to brain tissue, the MNA described in this work could be used to facilitate microinjections for a wide range of additional biological tissues, including those associated with the liver, breast, heart, kidney, veins, arteries, and prostate. For different injection targets with higher stiffness (e.g., E>250 kPa), alternative photomaterials could be used for esDLW-based printing, such as but not limited to fused silica glass-based photomaterials. Alternatively or additionally, the dimensions of the needles in the array could be changes from 10-μm-thick walls and 50 μm ODs to improve the mechanical strength for these higher stiffness injection targets.

Although the above example addresses the use of MNAs for injection of stem cells into biological tissues, the MNA can be adapted to other applications as well, for example, to remediate the deficits of single-needle injection strategies by expanding the delivery range via simultaneous, distributed microinjection. MNAs could be used to enhance other therapies that rely on fluidic microinjections, such as but not limited to delivery of therapeutic payloads (e.g., growth factors and viruses for gene therapy) into the brain or other biological tissues.

### Example(s) 2: Robotic Actuators

Endovascular interventions, which are medical procedures performed via blood vessels, can offer numerous benefits versus traditional “open” surgeries. Guidewire-catheter systems play an important role in endovascular interventions, which often involve: (i) inserting a thin, flexible guidewire into blood vessels through a small incision (arteriotomy), typically in the groin or wrist, (ii) navigating the guidewire manually (e.g., pushing, pulling, and/or rotating the guidewire by hand) through the vascular system under medical imaging (e.g., fluoroscopy) until reaching an intended site in the body, and then (iii) threading a catheter over the guidewire until the tip arrives at the desired location to deliver treatments or perform diagnostic procedures. Unfortunately, there are many cases in which interventionists encounter hazardous and/or insurmountable navigation challenges due to an inability to maneuver guidewire-catheter systems safely and effectively through complex, tortuous, and/or delicate vascular anatomy, which can lead to longer procedure times, increased risks of complications, and aborted procedures. Soft robotic actuation schemes can address these maneuverability deficits by facilitating on-demand steering capabilities for endovascular instruments, such as catheters, guidewires, and biopsy tools. However, conventional robotic actuation tools have relatively large size scales (e.g., 9-30 Fr). While such sizes may be suitable for certain cases (e.g., cardiac procedures in adult populations), they are not suitable for many other endovascular interventions that require considerably smaller instruments. For example, endovascular neurointerventions often need guidewires and catheters smaller than 2 Fr.

To address the above noted deficiencies of conventional technology, a manufacturing strategy for 3D microprinting integrated soft actuators directly atop multi-lumen tubing was developed as a pathway to realize fluidically actuated soft robotic surgical tools at miniaturized scales. To initially fabricate the custom multielement tubing, a multi-stage protocol was used. First, a polydimethylsiloxane (PDMS) microchannel (circular cross-sectional profile, 500 μm in diameter) was molded by pouring a 10:1 mixture of PDMS (Sylgard 184, Dow Corning, Corning, NY) over a filament (500 μm in outer diameter (OD)) in a 3D-printed mold and then allowing the PDMS to cure at 75° C. for 6 hours, such that the OD of the filament in the mold corresponds to the resulting tubing's OD. The PDMS microchannel was then removed from the mold, and the filament was extracted. 3D-printed alignment components (e.g., formed via liquid crystal display (LCD) 3D printing) were placed at the input and output of the PDMS channel to guide the positioning of capillaries. In particular, fused silica capillaries (Molex LLC, Lisle, IL) with the polyamide coating removed from the tips were fed through the alignment components and the PDMS micro channel. Third, the PDMS channel was filled with a liquid-phase photocurable material (3D Rapid Tuff sold by Monocure 3D, Sydney, Australia). Then, UV exposure was used to polymerize the photomaterial, in particular, by using a UV pen at a wavelength of 405 nm to cure the material around the capillaries. Finally, the multi-lumen tubing (with embedded capillaries) was removed from the PDMS mold and alignment components. In the above description of the fabricated example, multi-lumen tubing was formed by a multi-step molding process; however, the multi-lumen tubing could instead be formed via a vat photopolymerization process, such as stercolithography, DLP 3D printing, or LCD 3D printing.

The microfluidic system can include a pair of soft robotic actuators arranged in parallel, each actuator having seven bellows, with each bellow having an OD of 150 μm, a height of 40 μm, and a wall thickness of 10 μm. Small orifices (15 μm in diameter) were added to the top of each actuator to facilitate the clearing of uncured photoresist during development. To fabricate the bellows, the previously formed dual-lumen tubing was loaded into a custom tubing holder and the photoresist (IP-PDMS sold by Nanoscribe) was dispensed atop the tubing. The tubing was then loaded into the Nanoscribe Photonic Professional GT2 DLW system in the Dip-in Laser Lithography (DiLL) mode configuration with a 10× objective lens. The robotic actuators were then esDLW-printed directly atop the dual-lumen tubing, in particular, by using a pulsed femtosecond IR laser scanned in a point-by-point, layer-by-layer routine to selectively crosslink the photomaterial in designated locations, ultimately producing integrated soft actuators with the base fluidically sealed to the tubing and with the fluidic pathways of each actuator aligned to a respective one of the lumina of the tubing. To ensure a fluidic seal between the actuators and the tubing, the esDLW print was started with approximately 40 μm of overlap with the surface of the tubing. Following the esDLW printing process, the capillaries were backfilled with 100% isopropyl alcohol (IPA) and the actuator system was submerged in IPA for 60 minutes to develop the print. The robotic actuators were then rinsed with IPA to remove any remaining uncured photoresist and allowed to dry under air environment.

By virtue of the separate lumina of the tubing and separate actuators of the microfluidic system, each actuator can be pressurized independently via the corresponding input lumen to induce bending in the opposing direction, as shown in FIG. 10A. Although a dual-actuator, dual-lumen device is illustrated in FIG. 10A, the microfluidic system can be readily adapted to other configurations, for example, to increase the number of vertically arrayed bellows (e.g., to enhance the magnitude of bending/deformation at lower pressures) and/or the number of embedded capillaries and corresponding actuators (e.g., to expand the degrees of freedom for multidirectional bending and displacements).

To provide a proof-of-concept demonstration with relevance to steerable soft robotic guidewires, the dual-lumen microfluidic tubing was fabricated to serve as the body of a guidewire and the soft actuators were fabricated thereon to serve as a steerable tip. As described above, the tubing had two fused silica capillaries embedded in a photocured material. Fabrication results revealed that the dual-lumen tubing resolved with an approximately 1.5 Fr OD and a 40 μm inner diameter (ID) for each lumen. CAM simulations and the corresponding micrographs of the esDLW process for 3D microprinting the soft actuators are shown in FIG. 10B. When DLW-printing using the IP-PDMS photomaterial, however, the laser focal point or “voxel” is more difficult to visualize under brightfield microscopy (bottom of FIG. 10B) as compared to cases with other photoresists. The rapid scanning of the pulsed IR laser resulted in completion of the esDLW-printing process in less than 8.5 minutes using the 10× objective lens, which also allowed for the entire integrated soft actuator component to be 3D printed in a single run. As shown in FIG. 10C, a continuous interface was formed between the base of the esDLW-printed soft actuators and the top surface of the dual-lumen microfluidic tubing.

Numerical simulations of pressure-deformation behavior was performed using Abaqus software to provide insight into the operational functionalities of the 3D-microprinted integrated soft actuators. As shown in FIG. 11A, as the pressure applied to a single actuator increased, the tip bending angle toward the opposing direction increased proportionally. The quantified simulation results in FIG. 11B revealed this relationship between the applied pressure and the bending angle to be linear (linear regression analysis, r²=0.9634). For the nominal displacement for the tip of the integrated soft actuators, the change in the X position of the tip increased as the pressure increased. However, the Y position of the tip initially increased until reaching a maximum (e.g., suggesting an initial extension mode of the actuator), but then decreased thereafter due to the angular bending as the applied pressure continued to increase, as shown in FIG. 11C.

To evaluate the capability of regulating tip deformation via fluidic control schemes, micro-fluidic pressurization experiments were performed, in which DI water was infused into a single actuator of the esDLW-printed tip (e.g., via the corresponding capillary of the custom dual-lumen tubing) under distinct applied pressure magnitudes while monitoring tip deflection, the results of which are shown in FIG. 12A. In contrast to the FEA simulation results, which revealed tip deformation as soon as pressure was applied, the samples assessed experimentally did not reveal any deflection until the pressure reached 40 kPa, as shown in FIGS. 12B-12C. One potential basis for this behavior is stiction between adjacent bellows, as such phenomena are more prominent at smaller length scales. As the pressure increased, however, tip deformation was more consistent with that predicted by the simulation results. In particular, after the onset of deformation at pressures ≥40 kPa, the quantified results for the tip bending angle in FIG. 12B suggested a linear relationship between bending angle and the applied pressure (linear regression, r²=0.9507). The quantified results for the nominal displacement for the tip of the integrated soft actuators revealed an additional difference in deformation behavior versus the simulation results. Specifically, while the simulations showed a peak Y displacement with increasing pressure, as shown in FIG. 11C, the experiments revealed that the Y position of the esDLW-printed tip continued to increase with increasing pressure over the range of magnitudes investigated, as shown in FIG. 12C. These results suggest that both bending and extension modes contribute to the deformation behavior, which may stem from unique material properties originating from the point-by-point, layer-by-layer DLW-printing process. Throughout the experiments, no instance of undesired leakage were observed between the base of the integrated soft actuators and the top surface of the dual-lumen tubing during experimentation, suggesting sufficient print-surface fluidic interface integrity.

Such fluidically actuated soft robotic surgical tools hold unique promise for a variety of endovascular interventions. The above-noted experimental results demonstrated tip bending of nearly 60° for hydraulic input pressures of 130 kPa applied to a single actuator independently, in particular, for actuators formed by seven bellows each and a total height of less than 700 μm. However, embodiments of the disclosed subject matter are not limited to this particular structure. Rather, the disclosed techniques can be readily adapted and/or expanded upon to provide actuators with different performance characteristics. For example, by using the DLW 3D printer to print structures with heights on the order of centimeters (e.g., without compromising feature resolution), the height of the esDLW-printed soft actuators could be increased to enhance the deformation dynamics (e.g., the magnitude of the tip bending angle and/or displacement achieved at low pressures) as desired.

Alternatively or additionally, the multi-lumen tubing configuration could be extended to form three-lumen tubing upon which three-actuator tip designs can be printed to expand the degrees of freedom of the tip deflections and, in turn, system steerability. Thus, in another fabricated example, LCD 3D printing was used to form a microchip with three externally-accessible microchannels (each having a diameter of 200 μm), as shown in FIG. 13A, and esDLW was used to 3D print a microrobot having three actuators (each having a diameter of 360 μm) directly atop and fluidically sealed to the microchannels of the LCD 3D-printed microfluidic chip, as shown in FIG. 13B. Following development, pressure can be applied to the actuators independently or in tandem via the microchip channels to actuate the robot (e.g., as shown in FIG. 2B).

The LCD 3D-printed microchip was designed to enable facile loading into the Nanoscribe DLW 3D printer. Computer-aided manufacturing (CAM) simulations and corresponding micrographs of the 20-min soft robot esDLW printing process are shown in FIG. 13C. The soft robot was printed using the flexible photomaterial, IP-PDMS, and was developed in IPA for 60 minutes to remove uncured photoresist. Fabrication results for the completed soft robot suggested an effective seal between the esDLW-printed structure and the microchip, as shown in FIG. 13D. Cyclic burst-pressure experiments were performed to investigate the strength of the print-to-chip fluidic seal. In particular, pressure was applied in 5-second intervals for n=100 cycles for input pressures of 25 kPa and 50 kPa. The results, shown in FIGS. 14A-14B, did not indicate any signs of undesired burst or leakage. The omnidirectional movement capabilities of the soft robot were also investigated, the results of which are shown in FIGS. 15A-15C. Pressures were applied individually to each actuator via the microfluidic chip in 10 kPa intervals from −50 kPa (vacuum) to 50 kPa. Soft robot tip displacements were measured at each pressure for individual actuators.

More complex movement for the soft robotic actuator can be achieved by combining actuators in different configurations. For example, S-shaped configurations for the robot can be achieved by appropriate design of serially-connected actuators, for example, for use in endovascular interventions in the treatment of patent ductus arteriosus (PDA) in neonatal populations by mimicking the shape of in vivo cardiac vessel pathways (e.g., as shown in FIG. 16B). The ability to manage tight, opposing turns in small, tortuous vessels has the potential to save time and radiation exposure, while simultaneously mitigating risk by shortening procedure duration and increasing case.

Two 1.5 Fr, 2.5 mm-tall soft robotic guidewire designs were fabricated, in particular, a symmetric actuator design (e.g., as shown in FIG. 2C) and an asymmetric actuator design (e.g., as shown in FIG. 2D). Each design was able to actuate to S-shaped configurations under applied fluidic pressures. Each soft-robotic guidewire head was printed directly atop a previously formed capillary (e.g., fused silica polyimide-coated tube) via esDLW. Before starting the esDLW printing, fused silica polyimide-coated capillaries (Molex LLC, Lisle, IL) with an inner diameter of 75 μm and an outer diameter of 360 μm were cut and then rinsed successively with acetone and IPA. The capillary was then dried with N₂ gas, and then loaded into a plasma cleaner (Pic Scientific, Union City, CA) at 75 watts for 30 minutes. Immediately after removal from the plasma cleaner, the capillary tubes were submerged in a prepared silane solution of 0.5% v/v 3-(trimethoxysilyl) propyl methacrylate in ethanol for at least 30 minutes. This silanization process was done to increase adhesion between the fused silica surface and the resin used in the print. Finally, the capillaries were rinsed with acetone and water, and then blown dry with N₂ gas. The capillaries were then loaded into a Nanoscribe Photonic Professional GT2 DLW 3D printer in a custom-made holder. Although the capillary was formed by a non-additive manufacturing modality in the fabricated examples, the capillary could instead be formed via a vat photopolymerization process, such as stereolithography, DLP 3D printing, or LCD 3D printing, which could also eliminate the need for a custom-made holder to hold and align the capillaries during the esDLW process.

For the esDLW process (e.g., as shown schematically in FIG. 16A), IP-Dip2 resin (Nanoscribe) was deposited onto the 10× lens, and resin was injected back into the capillary from the printing surface to prevent air bubbles from exiting the center of the tube mid-print. The print was started with about 45 μm of overlap with the capillary to fill any unevenness in the capillary surface. The print was done with 100% laser power and a scan speed of 30,000 μm/s. The esDLW prints were subsequently developed inverted vertically inside of propylene glycol monomethyl ether acetate (PGMEA) on a hot plate heated to 35° C. for an hour, with fresh PGMEA swapped in at 30 minutes. During this stage, suction was pulled back through the print, infusing PGMEA into the guidewire head via clearing holes built into the top bellow of the design. The prints were then soaked in IPA overnight (˜12 hours).

The fused silica capillaries with the guidewire head printed on top were inserted into and sealed to larger fluidic tubing using UV glue. The experimentation of the guidewire head actuation was conducted using a Fluigent Microfluidic Control System coupled with OxyGEN software (Fluigent, France). Air was pressurized through tubing and stainless-steel catheter couplers (20G, Instech, Plymouth Mecting, PA) at pressures increasing from 0 kPa to 600 kPa, holding at each pressure for 2 seconds. ImageJ software (NIH) was used to quantify the actuation results. Fabrication results of the two designs can be seen in FIG. 16C, while FIG. 16D shows images of a catheter as it would be used with the guidewire. Both designs were manufactured with a 500 μm diameter and a 2500 μm height from the bottom of the bellows of the first section to the top of the bellows of the second section (but not including the cylindrical base), thereby achieving a high aspect ratio of 5:1. Additionally, the diameter of the guidewires can be measured as 1.5Fr, which is a small enough diameter to traverse successfully through an infant's heart.

To demonstrate the actuation capabilities of the guidewire heads, testing was conducted by increasing pressure input into the actuators. Video was taken of these experiments, and images were taken from these videos corresponding to the pressure inputs, for example, as shown in FIGS. 17A-17B for the symmetric actuator design and FIGS. 18A-18B for the asymmetric design. Each image was input to ImageJ to determine the radius of curvature and the XY locations of the middle and end of each guidewire head. The scale was set in millimeters based on the known capillary diameter of 360 μm, and the pixel to millimeter ratio was noted. Regions of Interest (ROIs) were then placed along the backbone of each segment of the actuator, with one point placed between each individual baffle. A circle was fitted to the ROIs. The circle can be further manipulated to ensure accurate alignment along the curvature of the actuator. Once fit to the actuator, the radius of the circle was calculated, representing the radius of curvature of the bent actuator. XY coordinates were collected by pixel count from three points along the length of the actuator: a) from the base of the baffle closest to the capillary, b) from the centroid of the connector between the two baffle segments, and c) from the outside tip of the baffle furthest from the capillary. By scaling the distance in pixels with the known pixel to millimeter ratio, the relative position of each of these points can be determined.

As shown in FIG. 17C, the radius of curvature for the symmetric design decreases as the input pressure increases. This data can be fitted to an exponential decrease with R² values of 0.94 and 0.85 for the bottom bellow and top bellow respectively. The symmetric design burst above 600 kPa and thus the maximum deformation was observed in the experiment. Bellow one was observed to have had a larger change in radius of curvature from 0 to 600 kPa, going from a radius of curvature from 21 mm to 2.2 mm. In contrast, bellow two underwent a change in radius from 11 mm to 2.7 mm. This difference is likely due to the small channel connecting the two sets of bellows restricting flow in such a way that it causes a capacitance effect inside of bellow one, increasing its actuation. This capacitance effect can also be observed in the XY tracking of the middle and tip of the guidewire head, as shown in FIG. 19A. To achieve the desired S-shape, the middle position should translate in one direction and the end position should translate in the opposite direction such that the end position is at the same horizontal position of the base. However, because bellow one was actuating so much more than bellow two, this behavior was not observed. Instead, both the middle and the end point translated in the same direction as bellow one when pressurized.

As shown in FIG. 18C, a similar trend was observed for the asymmetric design, in which the radius of curvature decreased as pressure increased, fit to an exponential curve with R² values of 0.73 and 0.97 for the bottom bellow and top bellow, respectively. Unlike the symmetric design, the asymmetric design did not burst during testing, and thus the entire range of the Fluigent system was utilized for testing. Both bellows in the asymmetric design resulted in a smaller radius of curvature at high pressure in comparison to the symmetric design at the same pressures; however, the bellows in the asymmetric design also began the experiment with a lower radius of curvature, likely due to shrinkage during post-processing. Throughout all the pressures tested, bellow two had a lower radius of curvature, implying increased actuation in comparison to bellow one. However, given that bellow two began testing with a smaller radius of curvature, this is likely also due to shrinkage during post processing. The XY tracking of the middle and end points in the asymmetric design can be seen in FIG. 19B. For the asymmetric design, the two points moved in opposite directions to create the desired S-shape.

### Example(s) 3: Microphysiological Systems

Microphysiological systems, also known as “organ-on-a-chip (OOC)” systems, hold considerable promise for applications such as drug screening, disease modeling, and personalized medicine. A barrier to OOC efficacy, however, stems from manufacturing challenges that hinder the accurate recreation of 3D architectures and material properties of in vivo organ systems. For example, conventional fabrication techniques can be poorly suited for OOC applications that require fully interweaving microvessels (e.g., like those of a kidney) and/or microvessels with tightly controlled circular IDs (e.g., ≤100 μm), thin walls or membranes (e.g., 10 μm), and/or custom micropores. In some cases, conventionally manufactured structures can also inhibit or prevent efficient characterization, for example, via microscopic imaging. To address one or more of the above noted deficiencies of conventional technology, a manufacturing strategy for 3D microprinting microvessels directly atop interfacing structures (e.g., microfluidic chip) was developed.

For example, LCD 3D printing was used to fabricate a microfluidic chip and complementary holder that can be: (i) assembled to facilitate “Two-Photon Direct Laser Writing (DLW)” of 3D polydimethylsiloxane (PDMS) microvessels (inner diameter=100 μm; wall thickness=5 μm; micropore diameters=5 μm) atop the microchip, and then (ii) disassembled to support orientations beneficial for conventional microscopy setups. As shown in FIG. 20A, the LCD 3D printing was used to print a microfluidic chip with externally accessible output ports, and a holder for the microfluidic chip. The bulk microfluidic chips, featuring 150 μm-in-diameter top fluidic access ports, were fabricated with Clear Microfluidics Resin (CADworks3D). Then, after integrating the microchip into the holder and loading the assembly into the DLW printer, esDLW was used to 3D nanoprint PDMS microvessel structures, with 3D tortuous architectures and predesigned micropores, directly atop and interfaced with the output ports of the microchip, as shown in FIG. 20B. The microfluidic vessels were printed using IP-PDMS photoresist (Nanoscribe). SEM micrographs of a representative microvessel structure is shown in FIG. 20C.

The microchip was designed to allow for placement on a flat surface for case of microscope visualization. As an exemplar, the inner surface of the microvessel, as shown in FIG. 21A, was activated by O₂ plasma for 1 minute, pre-coated with 100 μg/ml bovine fibronectin for 1 hour and stained with Alexa Fluor 405 dye for imaging, as shown in FIG. 21B. The microvessels were then endothelialized with primary human umbilical vein endothelial cells (HUVECs) (ATCC PCS-100-010™). The chamber was cultured in Vascular Cell Basal Medium under 37° C. and 5% CO₂ and was flipped over every 4 hours to ensure even cell distribution. The cells were stained with CellTracker™ Deep Red Dye for imaging, as shown in FIG. 21C. The results of FIGS. 21A-21D demonstrate ability of the new OOC system to enhance microscope visualization as compared to prior work, marking an important step towards achieving fully 3D PDMS-based OOC systems with improved microscope visualization efficacy as promising means to recapitulate in vivo biology.

In other fabricated examples, LCD 3D printing was used to fabricate a bulk 3D microfluidic device with externally accessible outlet ports, as shown in FIG. 22A. 3D microfluidic vessel structures were then printed via esDLW directly atop (and fluidically scaled to) the corresponding outlet ports of the DLP-printed microchip, as shown in FIG. 22B. The designs of the 3D PDMS microvessels (e.g., IDs, wall thicknesses, circularity, tortuosity, and micropores) can be customized as desired. Following development and preparation for cell cultures, cell suspensions or other biological fluids can be loaded into (and retrieved from) the esDLW-printed microvessels via the input/output ports of the DLP-printed microchip for in vitro studies.

In the fabricated examples, the microfluidic chip were designed with four ports at the sides that each connected to a corresponding macro-to-micro interface port on the top of the chip (diameter=100 μm). Models were exported as STL files and imported into slicing software (CHITUBOX, China) for the ELEGOO Mars 3 3D printer (ELEGOO, China). The microfluidic chips were printed using Clear Micro-fluidic Resin v7.0a (CADworks, Canada). The prints were developed by rinsing with ethanol and drying with N₂ gas several times until fully cleared. Lastly, the prints were further cured under UV light for 30 seconds.

Various microfluidic vessel structures were modeled using SolidWorks (Dassault Systèmes). The inter-weaving vessels were designed with IDs of 80 μm and wall thicknesses of 10 μm, while the independent microvessels were designed with IDs of 100 μm and wall thicknesses of 5 μm. Pre-designed micropores in the microvessels had diameters of 5 μm. The models were exported as STL files and imported into the computer-aided manufacturing (CAM) software, DeScribe (Nanoscribe GmbH, Germany). The PDMS-based photoresist, IP-PDMS (Nanoscribe), was dispensed atop the top ports of the microfluidic chip, and the device was loaded into the Nanoscribe Photonic Professional GT2 3D printer with the 10× objective lens and in the Dip-in Laser Lithography (DiLL) configuration. The esDLW process (hatching distance, layer height=300 nm) was initiated with 15 μm of overlap with the top surface of the chip to enhance fluidic sealing. Following the esDLW process, the device assembly was developed by immersing it into 50° C. IPA for 30 minutes, fresh room temperature IPA for another 30 minutes, and then allowed to dry under ambient conditions. The device assembly was placed under UV light for 60 seconds to cure potential residual resin.

Micrographs captured during the esDLW printing process of the microvessels were conducted using the built-in Carl Zeiss Axio Observer inverted microscope (Zeiss, Germany) within the Nanoscribe Photonic Professional GT2 DLW 3D printer. SEM images were obtained using a TM4000 Tabletop SEM (Hitachi, Tokyo, Japan). Brightfield and fluorescence micrographs of experimental results were performed using a Macro Zoom Fluorescence Microscope System (MVX10, Olympus) coupled with X-Cite Illuminators for fluorescence illumination and a charge-coupled device (CCD) camera (DP74, Olympus) for recording.

To prepare the device for cell testing, the device was immersed in ethanol and then DI water for 12 hours each, followed by rinsing with fresh DI water for 1 minute. The device exposed to oxygen plasma at 35 Watt for 60 seconds at a rate of 40 sccm using a Tergeo Plasma Cleaner (PIE Scientific, USA). Type I rat collagen coating solution (Sigma-Aldrich) was infused into the microvessels via the side ports of bulk microchip and incubated in a 37° C. CO₂ incubator for 1 hour. The system was then rinsed with both Phosphate Buffer Saline (PBS, Thermo Fisher Scientific) and Dulbecco's Modified Eagle's Medium (DMEM, Thermo Fisher Scientific). A suspension of MDA-MB-231 cells (1×10⁷ cells/mL) in culture medium (DMEM with 10% fetal bovine serum (FBS) and 1% penicillin/streptomycin was loaded into the vessel while 50 μL of culture medium was dispensed on top of the microvessel (to prevent drying out during the incubation). The device was then placed in a covered petri dish and cultured in the 37° C. CO₂ incubator for 12 hours. Cell viability was checked 2 days after cell seeding with Invitrogen™ LIVE/DEAD™ Viability/Cytotoxicity kit (Thermo Fisher Scientific). The LIVE/DEAD staining solution (2 mM Calcein AM and 4 mM ethidium homodimer-1 (EthD-1) in PBS) was loaded into the microvessel and incubated for 30 minutes. The vessel structure was then cleaned with PBS before imaging.

Microenvironmental testing was performed using the Fluigent Microfluidic Control System (MFCS) and Flow Rate Platform and OxyGen software (Fluigent, France), interfaced with the device ports via fluorinated ethylene propylene fluidic tubing (Cole-Parmer, Vernon Hills, IL) and stainless steel catheter couplers (Instech, Plymouth Meeting, PA). Positive input and output vacuum pressures for testing with 10% fluorescin-S-isothiocyanate (FITC) ranged from 0 to 20 kPa and 0 to 5 kPa, respectively. The total LCD-based 3D printing process for the bulk microfluidic device was completed in under 30 minutes, with each batch print able to produce up to 12 chips simultaneously. SEM micrographs of representative fabrication results revealed effective production of the tortuous vessels as well as the pre-designed micropores, as shown in FIGS. 23A-23B.

To evaluate the biocompatibility of the esDLW-printed PDMS-based microvessels (coated with type I collagen), investigations of cellular adherence and cell viability were performed using an epithelial cell line (MDA-MB-231, breast cancer cell line from adeno-carcinoma). Experimental results for MDA-MB-231 cells cultured on the inner lumen for 12 hours revealed that the 3D PDMS microvessels were able to support cell adherence and viability, as shown in FIGS. 24A-24C. To investigate the microenvironmental permeation dynamics of the microvessels facilitated by the pre-designed micropores and tuned via the pressures applied to the input and output, the system was immersed in DI water and then the infusion/permeation dynamics were observed for 10% FITC while applying positive pressure at the inlet and negative pressure (vacuum) at the outlet. As shown in FIG. 25A, flow was not initially observed without applying pressure at either the inlet or outlet. By applying a positive pressure of 15 kPa at the inlet along with a vacuum pressure of 5 kPa at the outlet, mainstream flow was retained within the microvessel, as shown in FIG. 25B. Vacuum application at the outlet was needed to prevent permeation through the arrayed micropores along the microvessel. For example, slightly larger pressure gradients between the inlet and the outlet, such as by applying a 20 kPa inlet pressure and a 4 kPa outlet vacuum pressure, resulted in partial external permeation near the portion of the microvessel closest to the inlet port, as shown in FIG. 25C. Furthermore, in the absence of any vacuum pressure at the outlet, an outlet pressure of 15 kPa resulted in considerable external permeation of the FITC solution, as shown in FIG. 25D. These results suggest that both the input and output pressures can be regulated on-demand to tune the microenvironmental permeation dynamics to control internal-to-external chemical-molecular communications.

The presented OOC fabrication strategy, which combines VPP and esDLW 3D printing, offers unique means to overcome the geometric restrictions of prior conventional approaches in recreating in vivo structures more accurately. Although LCD 3D printing was used above, alternative VPP (or potentially “material jetting” 3D printing approaches) could be similarly employed for bulk microdevice production. The above-noted results suggest that the fabricated microvessels can support cell/tissue culture and viability, and can be adapted to realize true-3D PDMS-based OOC systems with physiologically accurate architectures that, ultimately, recapitulate in vivo tissue- and organ-level physiology in vitro.

### CONCLUSION

Any of the features illustrated or described herein, for example, with respect to FIGS. 1A-25D, can be combined with any other feature illustrated or described herein, for example, with respect to FIGS. 1A-25D to provide systems, devices, structures, materials, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method of fabricating microfluidic system, the method comprising:
fabricating a first structure of the microfluidic system via a first additive manufacturing process, the first structure having at least one first fluidic port and at least one first conduit, each first conduit connecting to one of the at least one first fluidic port; and
fabricating a second structure of the microfluidic system on the first structure via a second additive manufacturing process, the second structure having at least one second conduit,
wherein the fabricating the second structure on the first structure is such that the at least one second conduit is sealed to the at least one first fluidic port and such that the at least one first conduit is in fluid communication with the at least one second conduit,
the second additive manufacturing process comprises ex situ direct laser writing, and
the first additive manufacturing process comprises an additive manufacturing modality different from the second additive manufacturing process.

2. The method of claim 1, wherein the first additive manufacturing process comprises a vat photopolymerization process.

3. The method of claim 2, wherein the vat photopolymerization process comprises stereolithography, digital light processing (DLP) 3D printing or liquid crystal display (LCD) 3D printing.

4. The method of claim 1, wherein the first structure comprises a plurality of tubes, each tube having a respective one of the at least one first fluidic port and the at least one first conduit.

5. The method of claim 4, wherein the second structure comprises an array of needles formed atop a first tube of the plurality of tubes, each needle having a respective one of the at least one second conduit, the second conduit of each needle being in fluid communication with the first conduit of the first tube.

6. The method of claim 5, wherein each needle is hollow with an opening at an end remote from the first tube, and the second conduit of each needle has a maximum diameter less than or equal to 50 μm.

7. The method of claim 6, further comprising flowing fluid into the first conduit of the first tube and dispensing the fluid simultaneously from the openings of the needles.

8. The method of claim 6, further comprising:
inserting the array of needles into a biological tissue; and
injecting the biological tissue via the array of needles with fluid from the first tube,
wherein the fluid comprises a drug, biological cells, or both.

9. The method of claim 5, wherein:
the first structure comprises one or more members connecting the first tube to others of the plurality of tubes; and
the method further comprises, after the fabricating the second structure on the first structure, removing the first tube, with the array of needles thereon, from the first structure by severing the one or more members.

10. The method of claim 1, wherein the first structure is adapted to fit and align within a machine for performing the ex situ direct laser writing.

11. The method of claim 1, further comprising, after the fabricating the second structure on the first structure, flowing fluid into the at least one second conduit via the first structure.

12. The method of claim 11, wherein the fluid contains biological cells.

13. A microfluidic system comprising:
a first structure having at least one first fluidic port and at least one first conduit, each first conduit connecting to one of the at least one first fluidic port, the first structure being formed by a first additive manufacturing process; and
a second structure coupled to the first structure, the second structure having at least one second conduit, the second structure being formed by a second additive manufacturing process,
wherein the at least one second conduit is sealed to the at least one first fluidic port and the at least one first conduit is in fluid communication with the at least one second conduit,
the second additive manufacturing process comprises ex situ direct laser writing, and
the first additive manufacturing process comprises an additive manufacturing modality different from the second additive manufacturing process.

14. The microfluidic system of claim 13, wherein:
the first structure comprises a plurality of tubes, each tube having a respective one of the at least one first fluidic port and the at least one first conduit; and
the second structure comprises an array of needles formed atop a first tube of the plurality of tubes, each needle having a respective one of the at least one second conduit, the second conduit of each needle being in fluid communication with the first conduit of the first tube.

15. The microfluidic system of claim 14, wherein:
each needle has a maximum outer diameter less than or equal to 100 μm;
each needle has a length of at least 500 μm;
each needle has an aspect ratio of length to outer diameter of at least 10:1;
the second conduit of each needle has a maximum diameter less than or equal to 50 μm;
a spacing between adjacent needles in the array is less than or equal to 100 μm; or
any combination of the above.

16. The microfluidic system of claim 14, wherein:
the first tube has a maximum outer diameter of at least 1 mm;
the first tube has a maximum inner diameter of at least 500 μm;
the first tube has a length of at least 5 mm;
the first tube has an outer diameter that varies along its length;
the first tube has an inner diameter that is substantially constant along its length; or
any combination of the above.

17. The microfluidic system of claim 14, wherein each needle is hollow with an opening at an end remote from the first tube.

18. The microfluidic system of claim 14, wherein the first structure comprises one or more members connecting the first tube to others of the plurality of tubes, the first structure is constructed such that the first tube is released from the first structure by severing the one or more members.

19. The microfluidic system of claim 13, wherein the at least one second conduit is substantially straight along its entire length.

20. The microfluidic system of claim 13, wherein the at least one second conduit of the second structure has a fluid therein, the fluid comprising a drug, biological cells, or both.
